(19) United States
(12) Patent Application Publication
(10) Pub. No.: US 2026/0244726 A1
(43) Pub. Date: Aug. 20, 2026

(54) Secure Biometric Authentication Architecture

(71) Applicant: Meta Platforms Technologies, LLC, Menlo Park, CA (US)

(72) Inventors: Jason Haensly, Seattle, WA (US); Hsuhua Yu, San Francisco, CA (US); Bo-Huei Lin, Sunnyvale, CA (US); Anish Kumar Goyal, Fremont, CA (US); Avdhesh Chhodavdia, Fremont, CA (US)

(21) Appl. No.: 19/535,983

(22) Filed: Feb. 10, 2026

Related U.S. Application Data
(60) Provisional application No. 63/760,099, filed on Feb. 18, 2025.

(51) Int. Cl. G06F 21/32; G06F 15/78; G06F 21/60; H04L 9/40

(52) U.S. Cl. CPC G06F 21/32; G06F 15/7825; G06F 21/602; H04L 63/02

(57) ABSTRACT

Systems and methods for secure biometric authentication using a companion system-on-a-chip (SoC) are provided. The companion SoC is configured to operate with reduced area and reduced power consumption compared to a main SoC and includes a machine-learning (ML) accelerator for biometric processing and a subsystem, isolated from general purpose processing of the main SoC, interconnected through a network-on-chip with access control firewalls restricting access to biometric sensor data to the ML accelerator and stored biometric templates to the subsystem. The ML accelerator is configured to generate validated sensor data by applying a biometric sensor data to an ML model and generate a biometric signature from the validated sensor data. The subsystem is configured to store encrypted biometric templates, authenticate the biometric signature against stored templates, and encrypt and verify authenticity of ML models used by the ML accelerator.

### CROSS-REFERENCE TO RELATED APPLICATIONS

This application claims the benefit of U.S. Provisional Patent Application 63/760,099 filed February 18, 2025, the entire content of which is incorporated herein by reference.

### TECHNICAL FIELD

The disclosed implementations relate generally to secure hardware architectures including but not limited to systems and methods for secure biometric authentication.

### BACKGROUND

Secure biometric authentication is increasingly important in modern electronic devices, particularly wearable and user devices. Biometric authentication provides a convenient and secure method for verifying user identity by leveraging unique physiological characteristics. Protecting biometric data is critical because, unlike passwords or PINs, biometric identifiers cannot be easily changed if compromised. Traditional approaches to biometric authentication have typically relied on the main system-on-a-chip (SoC) to perform the authentication processing.

However, using the main SoC for biometric authentication presents several challenges. The main SoC typically executes a high-level operating system that supports third-party applications, which increases the attack surface and exposes sensitive biometric data to potential vulnerabilities in the operating system or applications. Furthermore, processing biometric data on the main SoC makes it difficult to maintain hardware-level isolation of sensitive biometric templates and raw sensor data from general-purpose computing operations, increasing the risk of side-channel attacks and unauthorized access to biometric information. Additionally, the main SoC is generally optimized for computational throughput rather than power efficiency, resulting in higher power consumption during biometric processing operations, which is particularly problematic for battery-constrained wearable devices.

### SUMMARY

Accordingly, there is a need for systems and methods that provide secure biometric authentication separate from the main SoC (e.g., using a companion SoC). The techniques described herein provide power management benefits. For example, low-power companion SoCs can be used for always-on authentication. Some embodiments include specialized hardware accelerators for specific authentication methods. For example, the companion SoC architectures described herein enable enhanced protection against side-channel attacks, independent secure boot processes, and/or persistent authentication states during main SoC power-down periods, while providing dedicated secure storage for credentials and maintaining overall system efficiency.

Described herein are secure biometric authentication systems, e.g., implemented in companion SoCs that operate with reduced power and area constraints as compared to a main SoC. Some of the disclosed systems include a low-power deep learning accelerator that efficiently processes biometric data through frame quality validation and signature generation, e.g., working in conjunction with a dedicated root-of-trust subsystem that manages encrypted biometric templates and machine learning models. These components may be interconnected through a network-on-chip (NoC) featuring a firewall that enforces access controls. Such an architecture ensures security by processing biometric data entirely within the companion SoC, with the root-of-trust subsystem maintaining secure storage for templates and managing cryptographic operations. The systems may implement secure communication channels with replay protection, rate limiting for authentication attempts, and/or hardware-level isolation of sensitive data. In some embodiments, only signed authentication results are transmitted to the main SoC, while raw biometric data and templates remain protected within a companion chip. The above techniques can provide both improved power efficiency and enhanced security compared to traditional main SoC implementations.

In one aspect, some embodiments include a system for biometric authentication in a wearable device with a companion SoC that has reduced power and area constraints compared to a main SoC. The companion SoC may include a low-power deep learning accelerator that operates with higher power efficiency than the main SoC for biometric processing. The deep learning accelerator may apply a frame quality model to validate biometric sensor data. The deep learning accelerator may generate a biometric signature from validated sensor data. The companion SoC may include a root-of-trust subsystem isolated from the general-purpose processing of the main SoC. The root-of-trust subsystem may store encrypted biometric templates., authenticate the biometric signature against stored template, and encrypt machine learning models used by the deep learning accelerator. The root-of-trust subsystem may also verify authenticity of the machine learning models before use. The companion SoC may include an NoC interconnecting the deep learning accelerator and root-of-trust subsystem. The companion SoC may include a firewall implemented in the NoC. For example, the firewall may restrict access to biometric sensor data to only the deep learning accelerator. As an example, the firewall may restrict access to stored biometric templates to only the root-of-trust subsystem.

In another aspect, some embodiments include a method of enrolling biometric data in a system (e.g., a companion SoC). The method includes receiving an authenticated enrollment request at a root-of-trust subsystem, and loading authenticated biometric processing models into a deep learning accelerator. The method also includes validating quality of sensor data using a first model, and generating a biometric signature from validated sensor data using a second model. The method further includes encrypting the biometric signature with a hardware-protected key, and storing the encrypted signature as a template in secure storage accessible only to the root-of-trust subsystem.

In another aspect, some embodiments include a method of authenticating a user using a system (e.g., a companion SoC). The method includes receiving an authentication request at a root-of-trust subsystem, and verifying a rate limit has not been exceeded for authentication attempts. The method also includes loading authenticated biometric processing models, and receiving sensor data through a secure path. The method further includes validating quality of the sensor data using a first model, and generating a biometric signature from validated sensor data using a second model. The method also includes comparing the generated signature against stored templates in secure storage, and returning an authentication result via an authenticated channel with replay protection.

In another aspect, some embodiments include a method of re-enrolling biometric data in a system (e.g., a companion SoC). The method includes detecting that a biometric authentication has failed based on a user’s current appearance not matching enrolled templates, and receiving confirmation of successful PIN authentication. Upon successful PIN authentication, the method includes initiating a new enrollment sequence. The new enrollment sequence includes coordinating with a message control unit to load biometric processing models. The new enrollment sequence includes checking frame quality of sensor data using a frame quality model. The new enrollment sequence includes calculating a signature from sensor data using a deep learning accelerator. The new enrollment sequence includes storing the signature as an encrypted template in secure storage accessible only to a root-of-trust subsystem.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive of list of electronic devices that can, either alone or in combination (e.g., a system), include instructions that cause the performance of methods and operations associated with the presentation and/or interaction with an XR experience include an extended-reality headset (e.g., a mixed-reality (MR) headset or a pair of augmented-reality (AR) glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described implementations, reference should be made to the Description of Implementations below, in conjunction with the following drawings in which like reference numerals refer to corresponding parts throughout the figures.

FIG. 1 is a schematic diagram of an example architecture for biometric authentication in accordance with some embodiments.

FIG. 2 is a block diagram of an example biometric authentication system using a companion SoC in accordance with some embodiments.

FIG. 3A is a flowchart of an example method of enrolling biometric data in accordance with some embodiments.

FIG. 3B is a flowchart of an example method of securely processing biometric sensor data, in accordance with some embodiments

FIG. 4 is a flowchart of an example method of authenticating a user in accordance with some embodiments.

FIG. 5 is a flowchart of an example method of re-enrolling biometric data in accordance with some embodiments.

FIGS. 6A, 6B, 6C-1, and 6C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

The present disclosure describes, amongst other things, secure biometric authentication architectures that leverage companion system-on-a-chip designs to address the unique challenges of processing sensitive user data in wearable devices. As devices like augmented reality headsets and smart watches become more prevalent, there is an increasing need to perform user authentication in a manner that balances security, power efficiency, and form factor constraints.

In some embodiments described herein, a companion SoC operates alongside a main SoC to provide dedicated biometric processing capabilities while maintaining hardware-level isolation of sensitive data. Consider, for example, an augmented reality headset that utilizes eye tracking cameras to capture periocular biometric data. Rather than sending this sensitive information to the cloud or even to a main processor, the data is processed entirely within the companion SoC to generate authentication signatures, keeping raw biometric information away from the main processor and its high-level operating system.

The companion SoC architecture described in various embodiments includes a deep learning accelerator configured to validate sensor data quality and generate biometric signatures, working hand-in-hand with a root-of-trust subsystem that manages encrypted templates and cryptographic operations. The network-on-chip interconnecting these components may implement firewall mechanisms that restrict access to biometric sensor data and stored templates based on subsystem identity. To illustrate, in a smart watch application, the firewall may permit only the deep learning accelerator to access raw fingerprint sensor data while restricting template access to the root-of-trust subsystem.

By offloading biometric processing to a companion SoC with specialized hardware accelerators, wearable devices may achieve lower power consumption compared to performing equivalent operations on a general-purpose main processor. In some cases, the companion SoC may continue to maintain authentication state during periods when the main SoC is powered down, enabling always-on authentication capabilities. The hardware-level isolation provided by the network-on-chip firewall may reduce exposure of biometric data to vulnerabilities present in the main SoC’s operating system or third-party applications, and the rate limiting mechanisms implemented within the root-of-trust subsystem may help prevent brute force attacks on the authentication system. The above summary provides a brief introduction to the disclosed concepts and is not intended as a limitation on the scope of the present disclosure. The following description sets forth example methods, architectures, parameters, and the like, which should be recognized as descriptions of example embodiments rather than limitations on the scope of the present disclosure.

The following sections describe the disclosed embodiments in greater detail. The Overview section provides context regarding extended-reality systems and the various input modalities and device types that may incorporate the disclosed biometric authentication architectures. The Secure Hardware for Biometric Authentication section describes the architecture for biometric authentication, including the relationship between a main SoC and a companion SoC along with the various components that enable secure biometric processing, such as the deep learning accelerator, root-of-trust subsystem, network-on-chip, and firewall mechanisms. The Example Biometric Authentication Systems section presents specific hardware and software components of an example implementation, including the frame deep learning accelerator, root-of-trust subsystem, and the various memory and communication pathways used for secure data handling. The Enrolling and Authenticating Biometric Data section details methods of enrolling biometric data including the sequence of operations from receiving an enrollment request through storing encrypted templates, methods of securely processing biometric sensor data, methods of authenticating a user including rate limiting, secure sensor data paths, and replay-protected authentication results, and methods of re-enrolling biometric data to address scenarios where a user’s appearance changes over time. The Example Extended-Reality Systems section describes augmented-reality and mixed-reality systems in which the disclosed biometric authentication architectures may be implemented, including associated wearable devices and intermediary processing devices.

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user’s physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user’s hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user’s hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user’s hand or another finger, on the user’s leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user’s possession (e.g., smartphones, laptops, imaging devices, intermediary devices, and/or other devices described herein).

The input modalities as alluded to above can be varied and are dependent on a user’s experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) SoC controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read- only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors; (iii) IMUs for detecting, for example, angular rate, force, magnetic field, and/or changes in acceleration; (iv) heart rate sensors for measuring a user’s heart rate; (v) peripheral oxygen saturation (SpO₂) sensors for measuring blood oxygen saturation and/or other biometric data of a user; (vi) capacitive sensors for detecting changes in potential at a portion of a user’s body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user’s environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### Secure Hardware for Biometric Authentication

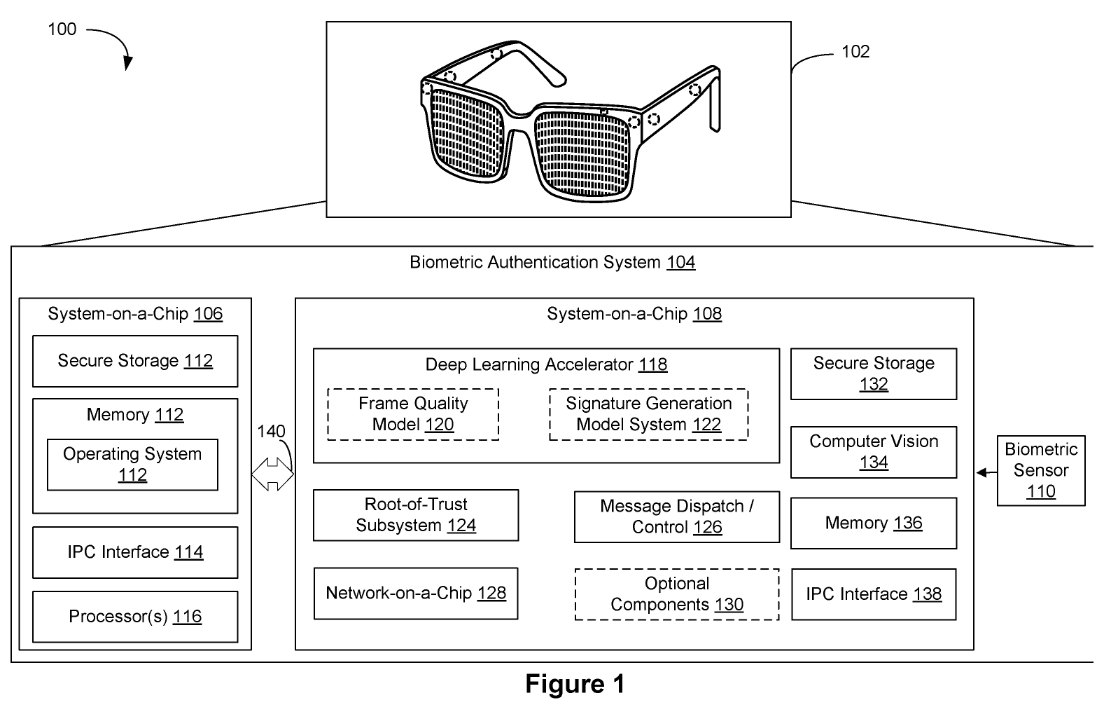

FIG. 1 is a schematic diagram of an example architecture 100 for biometric authentication, according to some embodiments. A biometric authentication system 104 can be used for secure biometric processing in an augmented reality (AR) headset 102. In some embodiments, the biometric authentication system 104 is used with other devices (e.g., other types of wearable devices, companion devices, or other types of devices). The biometric authentication system 104 represents a split computing architecture that can be implemented in various wearable devices and mobile computing systems, e.g., where secure biometric processing needs to be balanced with power, thermal, and/or form factor constraints. Beyond AR glasses or headsets 102, this system could be implemented in smart watches, fitness bands, medical wearables, or any head-mounted display device that requires secure biometric authentication. For example, the architecture 100 is useful in virtual reality headsets, mixed reality devices, smart glasses, or medical monitoring devices, which require secure processing of sensitive biometric data.

The architecture 100 divides processing between an SoC 106 and an SoC 108, connected through an interface 140 (e.g., a Peripheral Component Interconnect Express (PCIe) interface). In accordance with some embodiments, the SoC 106 may be a main SoC, and the SoC 108 may be a companion SoC. The main SoC (e.g., SoC 106) implements general computing through integrated components. Secure storage 112 can use, for example, one-time programmable memory for root keys, eFuses for device-specific keys, and/or secure flash memory with hardware encryption to protect cryptographic functions and sensitive data. System memory 112 can include RAM for active processing and ROM for core system components and bootloader code. An operating system 112 manages resources and maintains security boundaries between general applications and secure operations. The Inter-Processor Communication (IPC) interface 114 provides protected communication (e.g., using hardware-enforced security boundaries and encrypted channels), while processors 116 execute general computing tasks. In some embodiments, the main SoC (e.g., SoC 106) executes a high-level operating system that supports third-party applications. In some embodiments, the main SoC (e.g., SoC 106) is optimized for computational throughput rather than power efficiency. The main SoC 106 may be any processor or processing system that performs general-purpose computing tasks for a device.

In accordance with some embodiments, the companion SoC (e.g., SoC 108) can be used to implement efficient biometric processing with reduced power and area constraints. In some embodiments, the companion SoC (e.g., SoC 108) includes a deep learning accelerator 118. In some embodiments, the companion SoC achieves a higher power efficiency than the main SoC (e.g., SoC 106). In some embodiments, a deep learning accelerator may be an accelerator using specialized hardware optimized for matrix multiplication and neural network operations. In some embodiments, the accelerator 118 includes a frame quality model 120 that validates incoming biometric data from sensor 110 against quality parameters like image clarity, positioning, and/or lighting conditions. In some embodiments, the accelerator 118 includes a signature generation model system 122 that creates unique biometric signatures through specialized feature extraction. A root-of-trust subsystem 124 provides security through a dedicated security processor with encrypted storage and secure boot mechanisms. The subsystem 124 manages template encryption, authenticates signatures, verifies model authenticity, and/or enforces access controls while maintaining hardware-level isolation from the main SoC (e.g., SoC 106). The network-on-chip 128 implements secure interconnection through hardware-level firewalls and access controls. The network-on-chip 128 can implement dedicated channels between components using point-to-point connections. These channels can carry different types of traffic including control signals, raw sensor data, and processed biometric data. The firewall can be implemented through access control lists at each network interface point, with separate controls for read and write operations. In some embodiments, the companion SoC (e.g., SoC 108) comprises one or more microcontroller units (MCUs), digital signal processors (DSPs), and/or hardware accelerators organized into distinct subsystems. In some embodiments, the companion SoC (e.g., SoC 108) encapsulates sensitive data processing, e.g., to prevent exposure to vulnerabilities present in the high-level operating system running on the main SoC (e.g., SoC 106).

In some embodiments, the companion SoC (e.g., SoC 108) includes computer vision capabilities 134 that preprocess raw sensor data before deep learning processing. A message dispatch/control component 126 manages secure communication between subsystems. Additional secure storage 132 provides protected space for templates and sensitive data, while memory 136 implements separate regions for different security domains. An IPC interface 138 enables protected communication with the main SoC (e.g., SoC 106).

As used herein, the term “deep learning” refers to machine learning using a model having two or more layers that process input data to generate an output. In some embodiments, deep learning uses an artificial neural network having multiple layers of interconnected nodes, where each layer transforms input data and passes results to a subsequent layer. In some embodiments, deep learning uses a model that includes an input layer, one or more hidden layers, and an output layer, where the hidden layers extract features from input data at progressively higher levels of abstraction. In some embodiments, deep learning uses a neural network architecture that applies learned weights and activation functions across multiple layers to transform raw input data into a desired output representation. In some embodiments, deep learning refers to machine learning using a model comprising multiple processing layers that learn representations of data through training, where each layer learns to transform its input into a slightly more abstract representation.

As used herein, the term “deep learning accelerator” refers to specialized hardware designed to efficiently execute deep learning computations, such as matrix multiplications and neural network operations, with improved performance and power efficiency compared to general-purpose processors. In some embodiments, a deep learning accelerator comprises dedicated processing units optimized for parallel computation of tensor operations. In some embodiments, a deep learning accelerator includes specialized hardware blocks for performing convolution operations, activation functions, and pooling operations. Examples of deep learning accelerators include application-specific integrated circuits (ASICs) designed for neural network inference, graphics processing units (GPUs) configured for deep learning workloads, field-programmable gate arrays (FPGAs) programmed to execute neural network operations, and neural processing units (NPUs) integrated within system-on-a-chip architectures.

The system 104 maintains security through multiple mechanisms. Raw biometric data from sensor 110 does not leave the companion chip’s secure environment. Only authenticated results transfer through interface 140 to the main SoC (e.g., SoC 106), signed and protected against replay attacks. Hardware-level security features, encrypted storage 132, and controlled communication paths protect sensitive data throughout processing. Optional components 130 can extend functionality while maintaining security boundaries. This modular approach allows the system 104 to adapt to different requirements while preserving its core security architecture. The system’s structure enables maintaining security and isolation while allowing necessary data flows between processors 116 and the companion SoC (e.g., SoC 108), addressing the unique requirements of biometric authentication in AR devices 102.

As described above, the power-efficient companion SoC (e.g., SoC 108) is used for secure biometric processing while keeping the main SoC (e.g., SoC 106) for general computing. This can be applied in any scenario where sensitive biometric data needs to be processed securely in a resource-constrained device. The system’s ability to maintain security while managing power and thermal constraints makes it suitable for any wearable or mobile device that needs to perform continuous biometric authentication while operating within strict power and thermal limits. The modular architecture with the deep learning accelerator 118, root-of-trust subsystem 124, and network-on-chip 128 can be adapted for different types of biometric sensors 110 beyond eye tracking, such as fingerprint sensors, facial recognition cameras, or other biometric input devices. The security mechanisms and processing architecture are useful regardless of the specific type of biometric data being processed.

The companion SoC (e.g., SoC 108) can achieve power efficiency through several architectural features. For example, the deep learning accelerator 118 can utilize specialized hardware blocks optimized for biometric processing computational patterns. These can include, for example, dedicated matrix multiplication units that can process quantized weights and activations. The accelerator 118 can implement reduced precision arithmetic with configurable bit widths. Additionally, the accelerator 118 can employ weight stationary dataflow, which can keep model parameters local to processing elements. The companion SoC (e.g., SoC 108) can implement power gating and voltage scaling, where independent power domains can allow unused blocks to be powered down while active blocks can operate at reduced voltages.

The network-on-chip 128 can implement security through a hardware firewall architecture that can enforce access control at the transaction level. The firewall can include, for example, programmable lookup tables at network interfaces that can specify allowed initiators, targets, and access types for each memory region and peripheral. These tables can be programmed by the root-of-trust subsystem 124 during secure boot. Each transaction can be checked against these tables before proceeding through the network. The firewall can implement separate read and write permissions with configurable address ranges.

The root-of-trust subsystem 124 can derive device-specific cryptographic keys during manufacturing through a secure provisioning process. For example, the subsystem 124 can include a hardware random number generator that can generate a device root key. This key can be stored in one-time programmable memory, accessible only to trusted security firmware. The root key can be used to derive application-specific keys through key derivation functions for operations including secure boot verification, biometric template encryption, and authenticated communication.

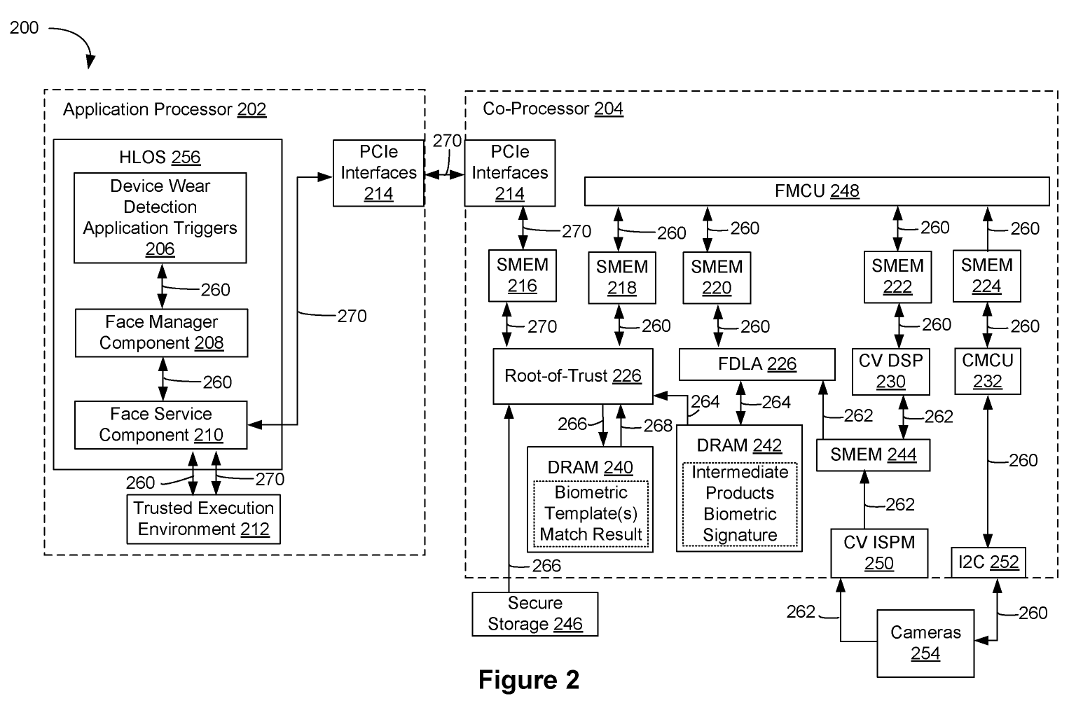

FIG. 2 is a block diagram of an example biometric authentication system 200 using a companion SoC architecture, according to some embodiments. The system is implemented across an application processor 202 (sometimes referred to as the main SoC, e.g., the SoC 106) and a co- processor 204 (sometimes referred to as the companion SoC, e.g., the SoC 108), which are interconnected via PCIe interfaces 214. The application processor 202 includes a high-level operating system (HLOS) 256 with device wear detection application triggers 206 (e.g., triggers for detecting when a wearable device like smart glasses is put on or removed), which triggers authentication events. A face manager component 208 extends the biometric manager functionality for coordinating authentication operations, while a face service component 210 extends the biometric service functionality and implements the biometrics face interface for companion chip communication. The architecture includes a trusted execution environment (TEE) 212 that implements secure inter-process communication (IPC) trusted applications. The TEE 212 can include hardware-isolated secure area that implements secure inter-process communication between the regular operating system and secure processing elements, for example.

Within the co-processor 204, several specialized components work together for secure biometric processing. A frame manager control unit (FMCU) 248 handles message dispatch and camera scheduling. A root-of-trust component 226 implements the periocular authentication state machine, which uses the eye region for biometric identification - particularly suitable for smart glasses with a clear view of the eye area. The root-of-trust 226 manages template storage and matching, implements rate limiting (e.g., limiting to 5 authentication attempts per minute to prevent brute force attacks), handles machine learning model security, configures firewalls, and manages secure inter-process communication. The frame deep learning accelerator (FDLA) 228 handles frame quality assessment (checking image clarity, eye visibility, lighting, and positioning) and signature generation, while the computer vision digital signal processor (CV DSP) 230 manages signature state machine operations and frame preprocessing. The camera management control unit (CMCU) 232 manages camera configuration.

The authentication rate limiting can be implemented through a token bucket algorithm where each authentication attempt consumes a token. For example, the system can replenish tokens at a configured rate and can maintain separate buckets for different types of authentication operations. When the bucket is empty, the system 200 can enforce a mandatory waiting period before allowing additional attempts.

The system 200 employs a memory and communication architecture with multiple shared memory (SMEM) blocks 216, 218, 220, 222, and 224 for inter-process communication, DRAM blocks 240 and 242 for storing biometric templates and intermediate processing data, and a computer vision instruction scratch pad memory (CV ISPM) 250 coupled with an I2C interface 252 for connecting to cameras 254. In accordance with some embodiments, the cameras 254 are configured for eye tracking. In accordance with some embodiments, the cameras 254 are configured to meet certain camera quality constraints (e.g., 400 x 400 x 4, 8 bits per pixel monochrome, 45Hz) and/or configuration restraints (e.g., four inwards facing cameras at full FOV and full resolution). Sensitive data is protected in secure storage 246. In some embodiments, the DRAM block 240 provides storage for biometric templates that are used as the basis for comparison during authentication attempts, while the DRAM block 242 stores match results generated during the signature comparison process.

The data flow within the system follows distinct pathways marked by different signal types. Control signals 260 coordinate between the FMCU 248 and other components through shared memory, while raw sensor data 262 (e.g., raw ET Frames) flows from the eye tracking cameras through the CV ISPM 250 to shared memory block 244. Computed signatures 264 move from the FDLA 228 to the root-of-trust 226, and stored signatures 266 exchange between secure storage and the root-of-trust 226. In some embodiments, match results 268 travel from the root-of-trust 226 to the application processor 202, while authenticated data 270 flows between processors via PCIe interfaces.

In some embodiments, the authentication sequence begins when a system event triggers a periocular authentication check. The face service 210 sends an authenticated IPC message to the root-of-trust 226 requesting a periocular authentication check. The root-of-trust 226 then coordinates with the FMCU 248 to load the necessary periocular firmware and machine learning models. The CV DSP 232 runs the signature state machine to enable and configure the eye tracking sensors 254 via the FMCU camera schedule and camera subsystem, preprocess raw eye tracking frames as needed, and run the frame quality and signature generation models on FDLA 230 to calculate a biometric signature. The root-of-trust 226 securely manages enrolled templates and performs matching operations. Finally, the root-of-trust 226 returns a pass/fail result over an authenticated and replay-resistant secure IPC channel back to the application processor 202.

FIG. 2 is an example implementation of the secure biometric authentication system 104, according to some embodiments. In FIG. 2, the main SoC (e.g., the SoC 106 in FIG. 1) is realized as the application processor 202, with its operating system 112 implemented through HLOS 256, secure storage and system memory 112 provided by the trusted execution environment 212, and IPC interface 114 enabled through PCIe interfaces 214. Within the companion SoC (e.g., the SoC 108 in FIG. 1), the deep learning accelerator 118 is implemented as the Frame Deep Learning Accelerator (FDLA) 228, which incorporates the frame quality model 120 and/or the signature generation 122 capabilities. The root-of-trust subsystem 124 maps to the root-of-trust component 226, while the Frame Manager Control Unit (FMCU) 248 handles the message dispatch 126 functionality. The network-on-chip 128 is realized through the various interconnections between components, with computer vision capabilities 134 implemented in the CV DSP 230. Secure storage 132 is provided through secure storage 246, while system memory 136 is distributed across multiple shared memory blocks (SMEM 216-224) and DRAM blocks (240, 242). The biometric sensor 110 is implemented through eye tracking cameras 254, with the interface 140 between SoCs enabled via PCIe interfaces 214. Additional security features are implemented through the trusted execution environment 212, detailed memory organization, and camera interfacing through I2C 252 and CV ISPM 250. This example implementation preserves the security architecture principles described above in reference to FIG. 1 while providing specific hardware and software components needed for practical deployment.

In this way, the architecture shown in FIG. 2 ensures secure processing of biometric data while maintaining efficient power usage and strong security boundaries between components. The system implements robust security measures including rate limiting, secure storage, and/or encrypted communication channels while providing the performance needed for real-time biometric authentication.

While FIGS. 1 and 2 illustrate specific implementations using a main SoC and a companion SoC architecture, other configurations may be employed in accordance with some embodiments. For example, the main SoC may be replaced with other types of processing systems or control circuitry, such as a field-programmable gate array (FPGA), an application-specific integrated circuit (ASIC), or a general-purpose processor coupled with appropriate security peripherals. Similarly, the companion SoC may be implemented using alternative processing architectures, including dedicated security processors, trusted platform modules (TPMs), or custom hardware security modules (HSMs) that provide the isolation and secure processing capabilities described herein. The deep learning accelerator may be realized through various hardware implementations beyond the specific FDLA configuration shown, such as neural processing units (NPUs), graphics processing units (GPUs) configured for inference workloads, tensor processing units, or programmable logic devices optimized for matrix operations. In some cases, the biometric processing functionality may be distributed across multiple discrete, secure components rather than integrated within a single companion chip. The network-on-chip interconnect may be replaced with other secure communication fabrics, including dedicated bus architectures with hardware-enforced access controls, point-to-point secure links, or encrypted communication channels between discrete processing elements. The root-of-trust functionality may be implemented through various secure element configurations, including embedded secure enclaves, external security coprocessors, or hardware-backed trusted execution environments integrated within a larger processing system.

### Example Biometric Authentication Systems

Some embodiments include a user authentication system in a wearable device with a companion chip (e.g., the co-processor 204) that has reduced power and area constraints compared to an application processor (e.g., the application processor 202). The companion chip 204 includes a frame deep learning accelerator (e.g., the FDLA 228) that operates with higher power efficiency than the application processor for biometric processing. The FDLA 228 applies a frame quality model to validate biometric sensor data and generates a biometric signature from validated sensor data. The companion chip 204 includes a root-of-trust 226 isolated from the general-purpose processing of the application processor. The root-of-trust 226 stores encrypted biometric templates, authenticates the biometric signature against stored templates, encrypts machine learning models used by the FDLA 228, and verifies authenticity of the machine learning models before use. The companion chip 204 includes a network-on-chip interconnecting the FDLA 228 and the root-of-trust 226. The companion chip includes a firewall implemented in the network-on-chip that restricts access to biometric sensor data to only the FDLA and restricts access to stored biometric templates to only the root-of-trust 226. In FIG. 2, the network-on-chip is shown by the various control flow and data flow arrows in the co-processor 204.

In some embodiments, the root-of-trust 226 derives cryptographic keys during manufacturing for secure communication with the application processor.

In some embodiments, the companion chip 204 includes a message dispatch component 204 that routes communication between the root-of-trust 226 and FDLA 228 through ring buffers in shared memory (SMEM).

In some embodiments, the FDLA 228 includes a frame quality model that validates that received sensor data meets quality criteria and a signature generation model that extracts identifying features only from validated sensor data.

In some embodiments, the firewall restricts access to machine learning models to only the FDLA 228 and root-of-trust 226. The firewall restricts access to sensor calibration data to only authorized subsystems.

In some embodiments, the root-of-trust 226 includes a rate limiter that throttles authentication attempts to prevent brute force attacks and includes secure storage for biometric templates encrypted with a hardware-protected device-specific key.

In some embodiments, the companion chip 204 includes a computer vision digital signal processor (CV DSP) that preprocesses raw sensor data before deep learning processing. The firewall allows the CV DSP access to raw sensor data.

In some embodiments, the companion chip 204 dynamically loads machine learning models based on authentication requests and maintains separate secure memory regions for template storage and model execution.

In some embodiments, the companion chip 204 includes a frame manager control unit (FMCU) 248 that coordinates workloads across subsystems through secure shared memory regions.

In some embodiments, the companion chip 204 processes biometric sensor data entirely within the companion chip, generates a signed authentication result message with a freshness indicator, transmits only the signed result message to the application processor 202, and retains the raw biometric data within the companion chip. In some embodiments, processing biometric sensor data entirely within the companion chip comprises raw biometric sensor data not being transmitted to or processed by the main SoC. In some embodiments, biometric sensor data does not leave the companion chip for processing by the main SoC. In some embodiments, raw biometric sensor data and intermediate processing results remain within the companion chip and are not accessible to the main SoC. In some embodiments, only authentication results, rather than raw biometric sensor data, are transmitted to the main SoC. processing biometric sensor data entirely within the companion chip comprises the processing of biometric sensor data not occurring within the main SoC.

### Enrolling and Authenticating Biometric Data

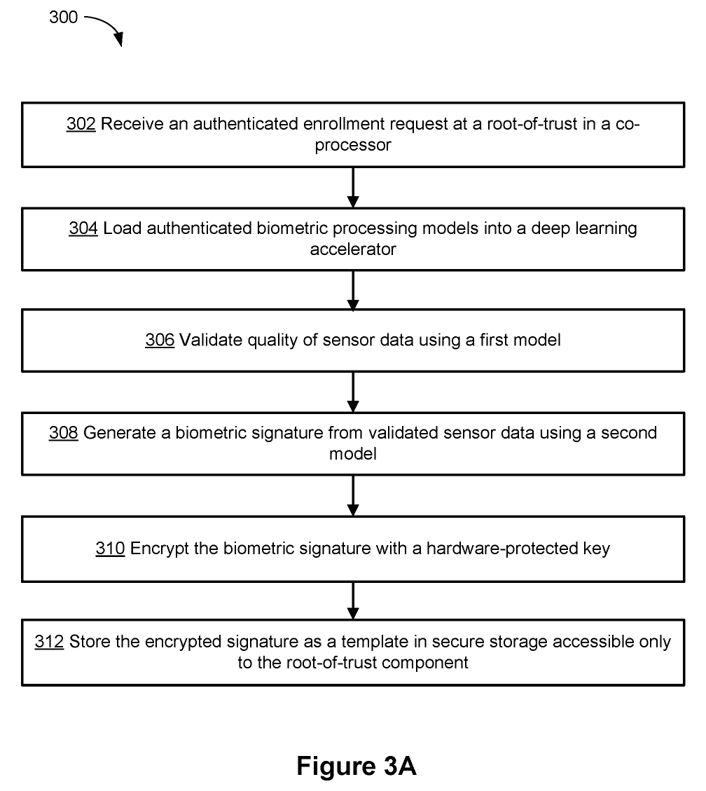

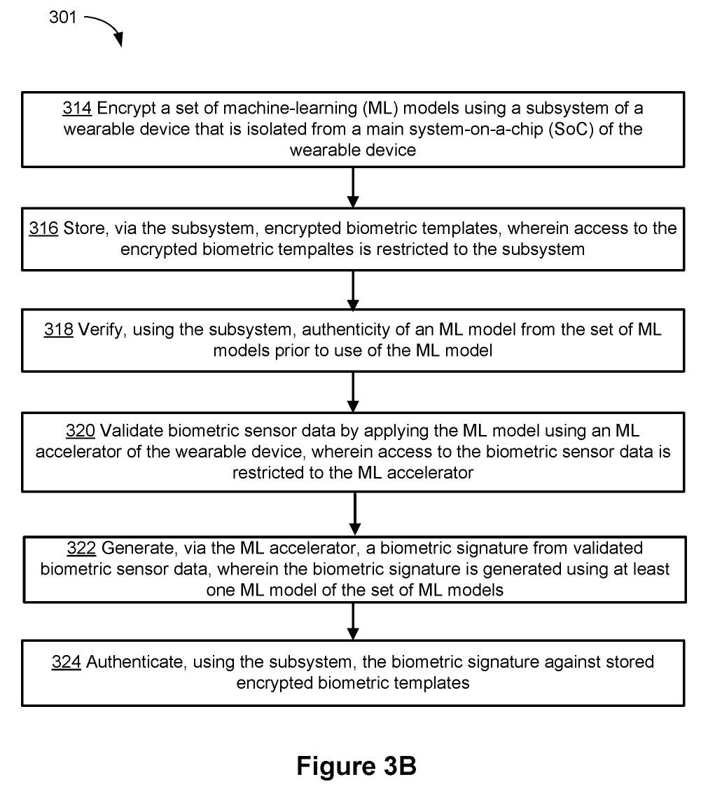

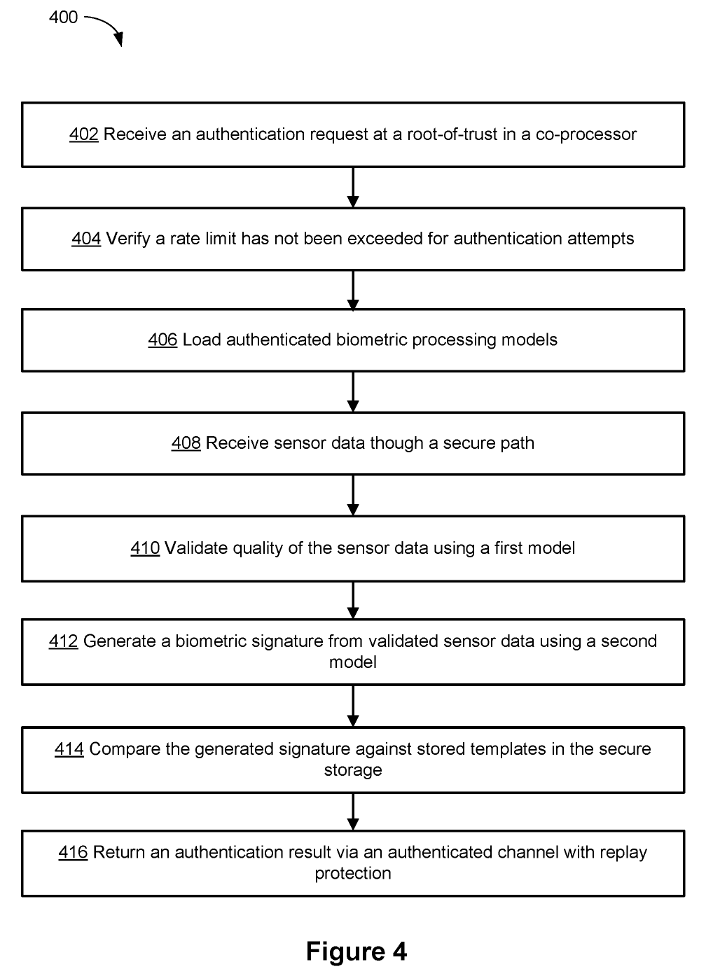

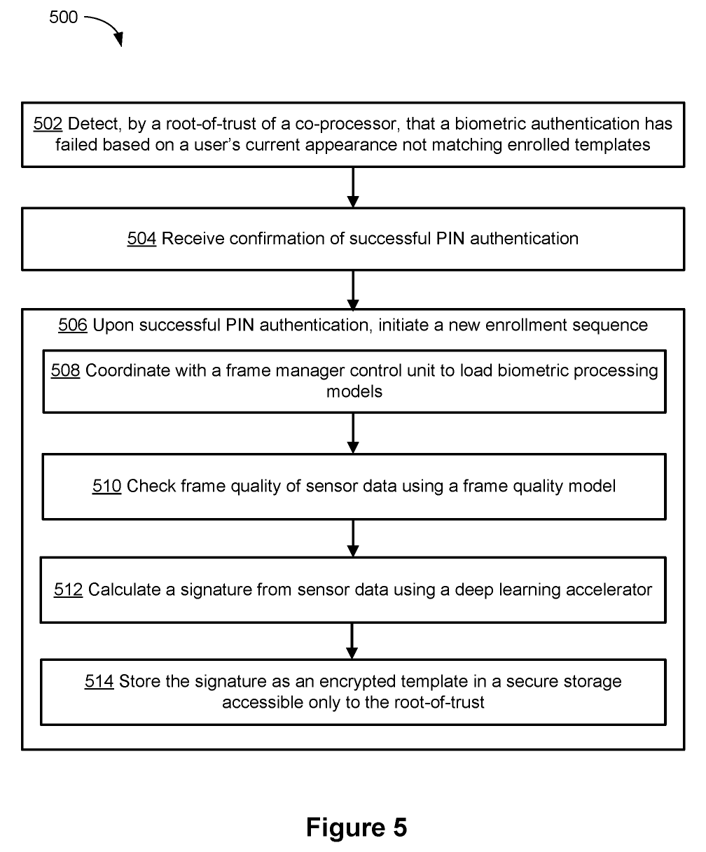

The secure biometric authentication architecture described above can be implemented through various methods that address different stages of the biometric authentication lifecycle. These methods can encompass initial enrollment of biometric data, secure processing of biometric sensor data within the companion SoC while maintaining isolation from the main SoC, user authentication against stored templates, and re-enrollment when a user’s appearance changes over time. FIG. 3A illustrates an example method 300 of enrolling biometric data, which establishes the initial biometric templates used for subsequent authentication. FIG. 3B illustrates an example method 301 of securely processing biometric sensor data, demonstrating how the companion SoC encrypts ML models, stores encrypted biometric templates with restricted access, verifies model authenticity, validates sensor data, generates biometric signatures, and authenticates signatures against stored templates. FIG. 4 illustrates an example method 400 of authenticating a user, which includes rate limiting to prevent brute force attacks, secure sensor data paths, and replay-protected authentication results. FIG. 5 illustrates an example method 500 of re-enrolling biometric data, which addresses scenarios where a user’s current appearance no longer matches enrolled templates by requiring PIN authentication before initiating a new enrollment sequence. The methods can be performed by the biometric authentication system 200, or another system or device as described herein.

FIG. 3A is a flowchart of an example method 300 of enrolling biometric data, according to some embodiments. The method can be performed by the biometric authentication system 200, or another system or device as described herein. The method includes receiving (302) an authenticated enrollment request at the root-of-trust 226 in the co-processor 204, loading (304) authenticated biometric processing models into a deep learning accelerator (e.g., the FDLA 228), validating (306) quality of sensor data using a first model, generating (308) a biometric signature from validated sensor data using a second model, encrypting (310) the biometric signature with a hardware-protected key, and storing (312) the encrypted signature as a template in secure storage accessible only to the root-of-trust component. The hardware-protected keys can be stored in one-time programmable memory regions accessible only to authorized subsystems. The system can derive separate keys for different operations including template encryption, model protection, and secure communication. These derived keys can be generated using key derivation functions with the hardware-protected root key as input.

In some embodiments, loading authenticated biometric processing models includes verifying authenticity of the models using the root-of-trust 226, decrypting the models using a key accessible only within the co-processor 204, and loading the models into protected memory regions (e.g., the secure storage 246) accessible only to authorized subsystems. The system can verify model authenticity, for example, by checking digital signatures attached to the model files. The root-of-trust subsystem can maintain a list of authorized model versions and can prevent loading of unauthorized or outdated models. Each model can be encrypted with a key specific to the intended subsystem.

In some embodiments, the method includes configuring sensor parameters through the camera management control unit (CMCU) 232 and preprocessing the sensor data using the CV DSP 230 before quality validation.

FIG. 3B is a flowchart of an example method 301 of securely processing biometric sensor data, according to some embodiments. The method can be performed by the biometric authentication system 200, or another system or device as described herein. The method includes encrypting (314) a set of machine-learning (ML) models using a subsystem of a wearable device that is isolated from a main SoC of the wearable device, storing (316), via the subsystem, encrypted biometric templates, wherein access to the encrypted biometric templates is restricted to the subsystem, and verifying (318), using the subsystem, authenticity of an ML model from the set of ML models prior to use of the ML model. The method further comprises validating (320) biometric sensor data by applying the ML model using an ML accelerator (e.g., the FDLA 228) of the wearable device, wherein access to the biometric sensor data is restricted to the ML accelerator, generating (322), via the ML accelerator, a biometric signature from validated biometric sensor data, wherein the biometric signature is generated using at least one ML model of the set of ML models, and authenticating (324), using the subsystem, the biometric signature against stored encrypted biometric templates.

In some embodiments, the set of ML models are encrypted such that plaintext versions of the ML models are not accessible to the main SoC. In some embodiments, the encrypted biometric templates are stored in secure storage that is inaccessible to the ML accelerator and the main SoC. In some embodiments, verifying authenticity of the ML model comprises checking a digital signature associated with the ML model and performing an anti-rollback check to confirm that the ML model has not been replaced with an earlier version. In some embodiments, validating biometric sensor data comprises determining whether the biometric sensor data meets one or more quality criteria including image clarity, positioning, and lighting conditions. In some embodiments, the ML accelerator discards biometric sensor data that does not meet quality criteria and provides feedback indicating a reason for discarding the data. In some embodiments, generating the biometric signature comprises extracting identifying features from validated biometric sensor data using a signature generation model that uniquely and persistently identifies a user.

In some embodiments, authenticating the biometric signature comprises decrypting one or more stored biometric templates using a hardware-protected key and determining whether a similarity score between the biometric signature and a stored template exceeds a security threshold. In some embodiments, the biometric sensor data, the biometric signature, and intermediate processing results remain within the companion SoC and are not transmitted to or accessible by the main SoC. In some embodiments, the subsystem returns an authentication result to the main SoC without transmitting the biometric signature or the stored biometric templates. In some embodiments, the method further comprises verifying that a rate limit has not been exceeded prior to authenticating the biometric signature, and the subsystem enforces a waiting period after a threshold number of failed authentication attempts. In some embodiments, the authentication result is signed using a key derived during manufacturing and includes a freshness indicator to prevent replay attacks.

FIG. 4 is a flowchart of an example method 400 of authenticating a user, according to some embodiments. The method can be performed by the biometric authentication system 200, or other system or device described herein. The method includes receiving (402) an authentication request at the root-of-trust 226, verifying (404) a rate limit has not been exceeded for authentication attempts, loading (406) authenticated biometric processing models, receiving (408) sensor data through a secure path (e.g., sensor data from the ET cameras 254 is obtained via the raw sensor data path in FIG. 2, via the CV ISPM 250), validating (410) quality of the sensor data using a first model, generating (412) a biometric signature from validated sensor data using a second model (e.g., using the models in the FDLA 228), comparing (414) the generated signature against stored templates in the secure storage 246, and returning (416) an authentication result via an authenticated channel with replay protection (e.g., via the SMEM 216, the PCIe 214, to the face service 210 and the trusted execution environment 212 in the application processor 202).

Rate limiting for biometric authentication can be implemented through a token bucket algorithm in the root-of-trust subsystem 124. For example, the system 100 can maintain separate token buckets for different authentication operations, each configured with specific parameters. Token counts can be stored in secure memory with redundancy and integrity protection. When rate limits are exceeded, the subsystem 124 can enforce a cooling off period before allowing additional attempts.

Sensor data can be protected through a secure path architecture. For example, raw biometric data from the sensor 110 can be transmitted through dedicated physical interfaces to the companion SoC (e.g., SoC 108). Within the companion SoC (e.g., SoC 108), sensor data paths can be implemented as point-to-point connections protected by the network-on-chip firewall. The secure path can include hardware encryption of data in transit, with keys managed by the root-of-trust subsystem 124. Sensor data buffers can be implemented in dedicated memory regions with memory protection restrictions.

In some embodiments, returning the authentication result includes generating a message authentication code using keys derived during manufacturing and including a nonce to prevent replay attacks.

In some embodiments, loading authenticated biometric processing models includes verifying model versions have not been rolled back and decrypting models using a key accessible only to authorized subsystems.

In some embodiments, comparing the generated signature includes loading multiple stored templates from the secure storage 246, performing comparisons against each loaded template, and returning a match result only when comparison exceeds a security threshold.

In some embodiments, the method includes coordinating workload distribution across subsystems through the FMCU 248 and maintaining secure data paths between subsystems using shared memory regions.

In some embodiments, the method includes validating calibration data stored for the biometric sensors by decrypting the calibration data using a key accessible only to authorized subsystems, verifying authenticity of the calibration data before use, and restricting access to the calibration data to only the root-of-trust 226 and camera subsystem.

FIG. 5 is a flowchart of an example method 500 of re-enrolling biometric data, according to some embodiments. The method can be performed by the biometric authentication system 200, or other system or device described herein. The method includes detecting (502) (e.g., by the root-of-trust 226) that a biometric authentication has failed based on a user’s current appearance not matching enrolled templates, receiving (504) confirmation of successful PIN authentication, and upon successful PIN authentication, initiating (506) a new enrollment sequence. The new enrollment sequence includes coordinating (508) with the FMCU 248 to load biometric processing models, checking (510) frame quality of sensor data using a frame quality model, calculating (512) a signature from sensor data using the FDLA 228, and/or storing (514) the signature as an encrypted template in the secure storage 246 accessible only to the root-of-trust 226.

The PIN authentication process for re-enrollment can implement security measures to prevent bypass attacks. For example, PIN verification can occur within the root-of-trust subsystem 124. The subsystem 124 can enforce delays between PIN attempts. After a set number of failed attempts, PIN authentication can be disabled and require administrator intervention to re-enable.

In some embodiments, replacing previously stored templates includes encrypting the new signature with a hardware-protected device-specific key and storing the encrypted signature in secure storage accessible only to the root-of-trust 226. In some embodiments, rather than replacing previously stored templates, the new enrollment sequence supplements the existing templates by adding the new encrypted signature as an additional template while retaining the previously stored templates. This supplemental approach can allow the system to maintain multiple valid biometric templates for a single user, accommodating gradual changes in the user’s appearance over time. In some embodiments, the system implements a hybrid approach that retains a subset of previously stored templates while adding new templates, e.g., with the selection of retained templates based on factors such as template age, match frequency, or match confidence scores. In some embodiments, the system enforces a maximum number of stored templates per user, and when this limit is reached, the oldest or least frequently matched templates may be removed to accommodate new templates. In some embodiments, the system allows the user to select whether to replace all existing templates or supplement them with new templates during the re-enrollment process.

(A1) In one aspect, some embodiments include a system for biometric authentication in a wearable device comprising a companion SoC and a main SoC, the companion SoC comprising: (i) a low-power deep learning accelerator operating with higher power efficiency than the main SoC for biometric processing, wherein the low-power deep learning accelerator is configured to: (a) apply a frame quality model to validate biometric sensor data, and (b) generate a biometric signature from validated sensor data; (ii) a root-of-trust subsystem isolated from the general-purpose processing of the main SoC, where the root-of-trust subsystem is configured to: (1) store encrypted biometric templates, (2) authenticate the biometric signature against stored templates, (3) encrypt machine learning models used by the deep learning accelerator, and (4) verify authenticity of the machine learning models before use; (iii) a network-on-chip (NoC) interconnecting the deep learning accelerator and root-of-trust subsystem; and (iv) a firewall implemented in the network-on-chip configured to: (I) restrict access to biometric sensor data to only the deep learning accelerator; and (II) restrict access to stored biometric templates to only the root-of-trust subsystem. In some embodiments, the main SoC is replaced with another type of system or control circuitry. In some embodiments, the companion SoC is replaced with another type of system or control circuitry.

(A2) In some embodiments of A1, the root-of-trust subsystem is configured to derive cryptographic keys during manufacturing for secure communication with the main SoC. In some embodiments, the cryptographic keys are derived using a hardware random number generator included within the root-of-trust subsystem. In some embodiments, the derived cryptographic keys are stored in one-time programmable memory that is accessible only to trusted security firmware. In some embodiments, the root-of-trust subsystem derives application-specific keys through key derivation functions using a hardware-protected root key as input. In some embodiments, separate keys are derived for different operations including secure boot verification, biometric template encryption, and authenticated communication. In some embodiments, the cryptographic keys enable message authenticity and integrity verification through HMAC operations with nonce values. In some embodiments, the derived keys are used to establish shared secrets for secure IPC channels between the companion SoC and the main SoC. In some embodiments, the key derivation process occurs during a secure provisioning process at manufacturing time.

(A3) In some embodiments of A1 or A2, the companion SoC further comprises a message dispatch component configured to route communication between the root-of-trust subsystem and the deep learning accelerator through ring buffers in shared memory. In some embodiments, the message dispatch component is implemented as part of a frame manager control unit (FMCU). In some embodiments, the message dispatch component routes messages between the root-of-trust subsystem, a computer vision digital signal processor, and the deep learning accelerator through mailboxes implemented as ring buffers in shared memory. In some embodiments, the shared memory comprises multiple shared memory (SMEM) blocks dedicated to inter-process communication between different subsystems. In some embodiments, the message dispatch component coordinates camera scheduling in addition to message routing. In some embodiments, the ring buffers provide asynchronous communication between subsystems while maintaining data integrity. In some embodiments, the message dispatch component manages workload coordination across subsystems through the secure shared memory regions.

(A4) In some embodiments of any of A1-A3, the deep learning accelerator comprises: (i) a frame quality model configured to validate that received sensor data meets quality criteria; and (ii) a signature generation model configured to extract identifying features only from validated sensor data. In some embodiments, the quality criteria include image clarity, positioning, lighting conditions, and eye visibility. In some embodiments, the frame quality model checks that the frame is valid by determining whether the biometric feature is in frame, in focus, and represents a live subject. In some embodiments, if the sensor data is invalid, the frame is discarded and a reason for discarding may be communicated through a callback via an acquired information field. In some embodiments, the signature generation model extracts salient features from an eye region that uniquely and persistently identify a single user. In some embodiments, the deep learning accelerator runs machine learning workloads with higher efficiency than general-purpose processors on the main SoC. In some embodiments, the deep learning accelerator utilizes specialized hardware blocks optimized for biometric processing computational patterns including dedicated matrix multiplication units. In some embodiments, the deep learning accelerator implements reduced precision arithmetic with configurable bit widths for power efficiency.

(A5) In some embodiments of any of A1-A4, the firewall is further configured to: (i) restrict access to machine learning models to only the deep learning accelerator and root-of-trust subsystem; and (ii) restrict access to sensor calibration data to only authorized subsystems. In some embodiments, the firewall is implemented through programmable lookup tables at network interfaces that specify allowed initiators, targets, and access types for each memory region and peripheral. In some embodiments, the lookup tables are programmed by the root-of-trust subsystem during secure boot. In some embodiments, each transaction is checked against the lookup tables before proceeding through the network-on-chip. In some embodiments, the firewall implements separate read and write permissions with configurable address ranges. In some embodiments, the machine learning models are encrypted such that their plaintext is only visible to authenticated companion SoC software with a legitimate need to access the data. In some embodiments, the sensor calibration data is encrypted such that the plaintext is only visible to authenticated companion SoC software with a legitimate need to access the data, including the root-of-trust subsystem and a camera subsystem. In some embodiments, the firewall restricts access to raw sensor frames to only a computer vision subsystem and the deep learning accelerator.

(A6) In some embodiments of any of A1-A5, the root-of-trust subsystem comprises: (i) a rate limiter configured to throttle authentication attempts to prevent brute force attacks; and (ii) a secure storage for biometric templates encrypted with a hardware-protected device-specific key. In some embodiments, the rate limiter is implemented through a token bucket algorithm where each authentication attempt consumes a token. In some embodiments, the system replenishes tokens at a configured rate and maintains separate buckets for different types of authentication operations. In some embodiments, when the token bucket is empty, the system enforces a mandatory waiting period before allowing additional attempts. In some embodiments, the rate limiter limits authentication attempts to a predetermined number per time period, such as five authentication attempts per minute. In some embodiments, the secure storage is accessible only to the root-of-trust subsystem and is encrypted with a hardware-protected, device-generated key. In some embodiments, the biometric templates stored in secure storage include computed signatures that are persisted over time and used as the basis for comparison during authentication attempts. In some embodiments, the secure storage also stores intermediate working products that may include user data in raw or processed form.

(A7) In some embodiments of any of A1-A6, the companion SoC further comprises a computer vision subsystem configured to preprocess raw sensor data before deep learning processing, where the firewall allows the computer vision subsystem access to raw sensor data. In some embodiments, the computer vision subsystem comprises a computer vision digital signal processor (CV DSP). In some embodiments, the computer vision subsystem runs a signature state machine that routes sensor frames to the appropriate machine learning model, routes biometric signatures to the root-of-trust subsystem and gracefully handles errors. In some embodiments, the computer vision subsystem performs frame preprocessing on raw sensor frames before providing them to the deep learning accelerator. In some embodiments, the computer vision subsystem enables and configures biometric sensors via a camera subsystem. In some embodiments, the computer vision subsystem shares access to the sensor stream with other functions such as eye tracking, allowing memory protection units to be configured to restrict access to only cores with legitimate need. In some embodiments, the firewall is configured such that only the computer vision subsystem and the deep learning accelerator require access to raw sensor frames.

(A8) In some embodiments of any of A1-A7, the companion SoC is configured to dynamically load machine learning models based on authentication requests; maintain separate secure memory regions for template storage and model execution. In some embodiments, the root-of-trust subsystem coordinates with a message dispatch component to load necessary biometric processing code, frame quality models, and signature generation models in response to authentication requests. In some embodiments, the machine learning models are authenticated and decrypted before loading into protected memory regions. In some embodiments, the root-of-trust subsystem maintains a list of authorized model versions and prevents loading of unauthorized or outdated models. In some embodiments, each model is encrypted with a key specific to the intended subsystem. In some embodiments, the separate secure memory regions include DRAM blocks for storing biometric templates and intermediate processing data. In some embodiments, processor memory protection units are configured to further restrict access to only the cores with a legitimate need to read or write the data.

(A9) In some embodiments of any of A1-A8, the system further comprises a message control unit configured to coordinate workloads across subsystems through secure shared memory regions. In some embodiments, the message control unit is implemented as an FMCU that is a general purpose microcontroller unit within a computer vision subsystem. In some embodiments, the message control unit primarily routes data and coordinates workloads across other subsystem cores. In some embodiments, the message control unit handles message dispatch between the root-of-trust subsystem, a computer vision digital signal processor, and the deep learning accelerator through mailboxes implemented as ring buffers in shared memory. In some embodiments, the message control unit manages camera scheduling by configuring and enabling biometric sensors via a camera management control unit. In some embodiments, the secure shared memory regions comprise multiple shared memory blocks dedicated to inter-process communication between different subsystems of the companion SoC.

(A10) In some embodiments of any of A1-A9, the companion SoC is configured to: (i) process biometric sensor data entirely within the companion SoC; (ii) generate a signed authentication result message with a freshness indicator; and (iii) transmit only the signed result message to the main SoC, where raw biometric data remains within the companion SoC. In some embodiments, processing biometric sensor data entirely within the companion SoC comprises raw biometric sensor data not being transmitted to or processed by the main SoC. In some embodiments, biometric sensor data does not leave the companion SoC for processing by the main SoC. In some embodiments, raw biometric sensor data and intermediate processing results remain within the companion SoC and are not accessible to the main SoC. In some embodiments, only authentication results, rather than raw biometric sensor data, are transmitted to the main SoC. In some embodiments, the signed authentication result message includes a message authentication code generated using keys derived during manufacturing. In some embodiments, the freshness indicator comprises a nonce to prevent replay attacks. In some embodiments, the root-of-trust subsystem returns a pass/fail result over an authenticated and replay-resistant secure IPC channel back to the main SoC. In some embodiments, the companion SoC encapsulates sensitive data processing to prevent exposure to vulnerabilities present in a high-level operating system running on the main SoC.

(B1) In another aspect, some embodiments include a method of enrolling biometric data in a companion SoC (or similar component). The method comprises: (i) receiving an authenticated enrollment request at a root-of-trust subsystem; (ii) loading authenticated biometric processing models into a deep learning accelerator; (iii) validating quality of sensor data using a first model; (iv) generating a biometric signature from validated sensor data using a second model; (v) encrypting the biometric signature with a hardware-protected key; and (vi) storing the encrypted signature as a template in secure storage accessible only to the root-of-trust subsystem. In some embodiments, the authenticated enrollment request is received from a face service component executing on a main SoC via a secure inter-process communication channel. In some embodiments, the authenticated enrollment request is triggered by a device wear detection event, an application request, or a user-initiated enrollment action. In some embodiments, the deep learning accelerator comprises an FDLA that includes specialized hardware blocks optimized for matrix multiplication and neural network operations. In some embodiments, the first model comprises a frame quality model that validates incoming biometric data against quality parameters including image clarity, positioning, lighting conditions, and eye visibility. In some embodiments, the second model comprises a signature generation model that extracts salient features from an eye region that uniquely and persistently identify a single user. In some embodiments, the hardware-protected key is stored in one-time programmable memory accessible only to trusted security firmware. In some embodiments, the hardware-protected key is a device-specific key generated during manufacturing. In some embodiments, the secure storage is encrypted with a hardware-protected, device-generated key and is accessible only to the root-of-trust subsystem. In some embodiments, the method is performed with a bio authentication enrollment user experience that instructs the user how to wear a head-mounted device.

(B2) In some embodiments of B1, loading authenticated biometric processing models comprises: (i) verifying authenticity of the models using the root-of-trust subsystem; (ii) decrypting the models using a key accessible only within the companion SoC; and (iii) loading the models into protected memory regions accessible only to authorized subsystems. In some embodiments, verifying authenticity of the models comprises checking digital signatures attached to the model files. In some embodiments, verifying authenticity of the models comprises performing a version anti-rollback check to confirm that the models have not been replaced with earlier versions. In some embodiments, the root-of-trust subsystem maintains a list of authorized model versions and prevents loading of unauthorized or outdated models. In some embodiments, each model is encrypted with a key specific to the intended subsystem. In some embodiments, the protected memory regions comprise DRAM blocks dedicated to storing biometric processing models and intermediate processing data. In some embodiments, processor memory protection units are configured to further restrict access to only the cores with a legitimate need to read or write the model data. In some embodiments, the models are encrypted such that their plaintext is only visible to authenticated companion SoC software with a legitimate need to access the data. In some embodiments, the authorized subsystems include only the deep learning accelerator and the root-of-trust subsystem. In some embodiments, loading the models is coordinated by a frame manager control unit that routes messages between the root-of-trust subsystem and the deep learning accelerator through ring buffers in shared memory.

(B3) In some embodiments of B1 or B2, the method further comprises: (i) configuring sensor parameters through a camera control subsystem; and (ii) preprocessing the sensor data using a computer vision subsystem before quality validation. In some embodiments, the CMCU manages physical interfaces to biometric sensors and configures the hardware. In some embodiments, the biometric sensors comprise eye tracking cameras configured to capture images at a resolution of 400 by 400 pixels at 8 bits per pixel monochrome at 45Hz. In some embodiments, the biometric sensors comprise four inward-facing cameras at full field of view and full resolution. In some embodiments, the computer vision subsystem comprises a computer vision digital signal processor (CV DSP) that performs frame preprocessing on raw sensor frames before providing them to the deep learning accelerator. In some embodiments, the computer vision subsystem runs a signature state machine that routes sensor frames to the appropriate machine learning model, routes biometric signatures to the root-of-trust subsystem, and gracefully handles errors. In some embodiments, the computer vision subsystem shares access to the sensor stream with other functions such as eye tracking, e.g., allowing memory protection units to be configured to restrict access to only cores with legitimate need. In some embodiments, a firewall implemented in a network-on-chip is configured such that only the computer vision subsystem and the deep learning accelerator require access to raw sensor frames. In some embodiments, the sensor data is received through a computer vision instruction scratch pad memory coupled with an I2C interface for connecting to the biometric sensors. In some embodiments, configuring sensor parameters comprises enabling and configuring the biometric sensors via a camera subsystem in response to coordination from a frame manager control unit.

(C1) In another aspect, some embodiments include a method of authenticating a user using a companion SoC (or similar component). The method comprises: (i) receiving an authentication request at a root-of-trust subsystem; (ii) verifying a rate limit has not been exceeded for authentication attempts; (iii) loading authenticated biometric processing models; (iv) receiving sensor data through a secure path; (v) validating quality of the sensor data using a first model; (vi) generating a biometric signature from validated sensor data using a second model; (vii) comparing the generated signature against stored templates in secure storage; and (viii) returning an authentication result via an authenticated channel with replay protection.

(C2) In some embodiments of C1, returning the authentication result comprises: (i) generating a message authentication code using keys derived during manufacturing; and (ii) including a nonce to prevent replay attacks. In some embodiments, the message authentication code is generated using an HMAC algorithm with a shared secret established during a secure provisioning process. In some embodiments, the nonce comprises a monotonically increasing counter value maintained in tamper-resistant storage. In some embodiments, the nonce comprises a timestamp synchronized between the companion SoC and the main SoC. In some embodiments, the authentication result includes a freshness indicator that expires after a predetermined time period. In some embodiments, the keys used for generating the message authentication code are derived from a hardware-protected root key using a key derivation function. In some embodiments, the authentication result is digitally signed using an asymmetric cryptographic algorithm. In some embodiments, the authentication result includes a session identifier that binds the result to a specific authentication request. In some embodiments, returning the authentication result further comprises encrypting the result using a session key negotiated between the companion SoC and the main SoC.

(C3) In some embodiments of C1 or C2, loading authenticated biometric processing models comprises: (i) verifying model versions have not been rolled back; and (ii) decrypting models using a key accessible only to authorized subsystems. In some embodiments, verifying model versions have not been rolled back comprises comparing a version number embedded in the model against a minimum version threshold stored in one-time programmable memory. In some embodiments, verifying model versions comprises checking a digital signature attached to the model file against a trusted public key stored in the root-of-trust subsystem. In some embodiments, the method further comprises maintaining a revocation list of compromised model versions that are rejected during loading. In some embodiments, decrypting models comprises using a symmetric key that is unique to the companion SoC and derived during manufacturing. In some embodiments, the models are encrypted using authenticated encryption that provides both confidentiality and integrity verification. In some embodiments, loading authenticated biometric processing models further comprises verifying that the models have not been modified by checking an integrity hash computed over the model data. In some embodiments, the models are loaded into a protected memory region that is isolated from other subsystems by hardware memory protection units. In some embodiments, loading authenticated biometric processing models is performed by the root-of-trust subsystem prior to transferring the decrypted models to the deep learning accelerator.

(C4) In some embodiments of any of C1-C3, comparing the generated signature comprises: (i) loading multiple stored templates from secure storage; performing comparisons against each loaded template; and (ii) returning a match result only when comparison exceeds a security threshold. In some embodiments, the security threshold is configurable based on a desired balance between false acceptance rate and false rejection rate. In some embodiments, the comparison comprises computing a similarity score between the generated signature and each stored template using a distance metric. In some embodiments, the distance metric comprises a cosine similarity measure, a Euclidean distance measure, or a Hamming distance measure. In some embodiments, the method further comprises weighting the comparison results based on the age or quality score of each stored template. In some embodiments, the multiple stored templates represent different enrollment sessions or different biometric capture conditions for the same user. In some embodiments, the comparison is performed sequentially against each template until a match is found or all templates have been evaluated. In some embodiments, the comparison is performed in parallel against multiple templates to reduce authentication latency. In some embodiments, the method further comprises updating a match frequency counter for each template to track which templates are most frequently matched. In some embodiments, returning a match result comprises providing a confidence score indicating the strength of the match in addition to a binary pass/fail indication.

(C5) In some embodiments of any of C1-C4, the method further comprises: (i) coordinating workload distribution across subsystems through a message control unit; and (ii) maintaining secure data paths between subsystems using shared memory regions. In some embodiments, the message control unit comprises a frame manager control unit that routes inter-process communication messages between the root-of-trust subsystem, a computer vision subsystem, and the deep learning accelerator. In some embodiments, the message control unit implements message routing through ring buffers allocated in shared memory. In some embodiments, the shared memory regions are partitioned into separate blocks dedicated to different types of data including control signals, raw sensor data, and processed biometric signatures. In some embodiments, maintaining secure data paths comprises configuring memory protection units to restrict read and write access to each shared memory region based on the identity of the requesting subsystem. In some embodiments, the method further comprises scheduling camera operations through the message control unit to coordinate sensor data capture with biometric processing. In some embodiments, the secure data paths are implemented as point-to-point connections protected by the network-on-chip firewall. In some embodiments, data transferred through the secure data paths is encrypted in transit using keys managed by the root-of-trust subsystem. In some embodiments, the method further comprises implementing flow control mechanisms to prevent buffer overflow in the shared memory regions.

(C6) In some embodiments of any of C1-C5, the method further comprises: (i) validating calibration data stored for the biometric sensors by decrypting the calibration data using a key accessible only to authorized subsystems, verifying authenticity of the calibration data before use, and restricting access to the calibration data to only the root-of-trust subsystem and camera subsystem. In some embodiments, the calibration data comprises sensor-specific parameters that optimize biometric capture quality for the particular hardware configuration. In some embodiments, the calibration data includes user-specific embeddings that may constitute personally identifiable information. In some embodiments, verifying authenticity of the calibration data comprises checking a digital signature or message authentication code attached to the calibration data. In some embodiments, the calibration data is encrypted using a device-specific key that is derived during manufacturing and stored in hardware-protected memory. In some embodiments, the method further comprises re-validating the calibration data periodically or upon detection of a potential tampering event. In some embodiments, restricting access to the calibration data is enforced by configuring the network-on-chip firewall to block access requests from unauthorized subsystems. In some embodiments, the calibration data is stored in a dedicated secure storage region that is separate from biometric templates. In some embodiments, the method further comprises logging access attempts to the calibration data for security auditing purposes.

(D1) In another aspect, some embodiments include a method of re-enrolling biometric data in a companion SoC (or similar component). The method comprises: (i) detecting that a biometric authentication has failed based on a user’s current appearance not matching enrolled templates; (ii) receiving confirmation of successful PIN authentication; and (iii) upon successful PIN authentication, initiating a new enrollment sequence comprising: (a) coordinating with a message control unit to load biometric processing models; (b) checking frame quality of sensor data using a frame quality model; (c) calculating a signature from sensor data using a deep learning accelerator; and (d) storing the signature as an encrypted template in secure storage accessible only to a root-of-trust subsystem.

In some embodiments, detecting that a biometric authentication has failed comprises determining that a similarity score between a generated biometric signature and all stored templates falls below a predetermined threshold. In some embodiments, the method further comprises tracking a count of consecutive failed authentication attempts and triggering a re-enrollment prompt after the count exceeds a configurable threshold. In some embodiments, receiving confirmation of successful PIN authentication comprises verifying the PIN within the root-of-trust subsystem rather than on the main SoC. In some embodiments, the method further comprises enforcing a delay between PIN entry attempts to prevent brute force attacks on the PIN verification process. In some embodiments, the method further comprises disabling PIN authentication after a predetermined number of failed PIN attempts and requiring administrator intervention to re-enable. In some embodiments, coordinating with a message control unit comprises sending IPC messages through ring buffers in shared memory to initiate model loading. In some embodiments, the message control unit schedules camera operations to capture biometric sensor data for the new enrollment sequence. In some embodiments, checking frame quality comprises validating that the biometric feature is in frame, in focus, and represents a live subject. In some embodiments, the method further comprises discarding frames that do not meet quality criteria and providing feedback to the user indicating a reason for discarding. In some embodiments, calculating a signature comprises extracting salient features from an eye region that uniquely and persistently identify the user. In some embodiments, the deep learning accelerator processes the sensor data using authenticated and decrypted machine learning models. In some embodiments, the method further comprises verifying authenticity of the biometric processing models before use by checking digital signatures and performing anti-rollback checks. In some embodiments, the new enrollment sequence is performed entirely within the companion SoC without transmitting raw biometric data to the main SoC. In some embodiments, the method further comprises preprocessing raw sensor data using a computer vision subsystem before providing the data to the deep learning accelerator. In some embodiments, the method further comprises configuring biometric sensors via a camera management subsystem prior to capturing sensor data for re-enrollment.

(D2) In some embodiments of D1, replacing previously stored templates comprises: (i) encrypting the new signature with a hardware-protected device-specific key; and (ii) storing the encrypted signature in secure storage accessible only to the root-of-trust subsystem. In some embodiments, the hardware-protected device-specific key is derived from a root key stored in one-time programmable memory. In some embodiments, the method further comprises deleting all previously stored templates before storing the new encrypted template. In some embodiments, the method further comprises retaining one or more previously stored templates while adding the new encrypted template, thereby maintaining multiple valid templates for the user. In some embodiments, the system enforces a maximum number of stored templates per user, and when this limit is reached, the oldest or least frequently matched templates are removed to accommodate new templates. In some embodiments, the method further comprises allowing the user to select whether to replace all existing templates or supplement them with new templates during the re-enrollment process. In some embodiments, the method further comprises associating metadata with each stored template indicating the enrollment date, match frequency, or quality score. In some embodiments, the secure storage is implemented in a dedicated memory region that is inaccessible to the main SoC and other subsystems of the companion SoC. In some embodiments, the method further comprises generating a confirmation message indicating successful re-enrollment and transmitting the confirmation to the main SoC via an authenticated channel with replay protection. In some embodiments, the confirmation message includes a freshness indicator to prevent replay attacks. In some embodiments, the method further comprises logging the re-enrollment event for security auditing purposes while maintaining privacy of the biometric data. In some embodiments, the method further comprises invalidating any cached authentication states on the main SoC following successful re-enrollment. In some embodiments, the method further comprises requiring the user to complete multiple successful authentications against the new template before removing previously stored templates.

(E1) In one aspect, some embodiments include a system for biometric authentication in a wearable device comprising a main SoC and a companion SoC that is configured to operate with reduced area and reduced power consumption compared to the main SoC, the companion SoC comprising: (i) an ML accelerator for biometric processing, wherein the ML accelerator is configured to: (a) generate validated sensor data by applying a biometric sensor data to an ML model, and (b) generate a biometric signature from the validated sensor data; (ii) a subsystem isolated from general-purpose processing of the main SoC, wherein the subsystem is configured to: (1) store encrypted biometric templates, (2) authenticate the biometric signature against stored templates, (3) encrypt one or more ML models used by the ML accelerator, and (4) verify authenticity of the one or more ML models before user; (iii) a network-on-chip (NoC) interconnecting the ML accelerator and subsystem; and (iv) a firewall implemented in the network-on-chip configured to: (I) restrict access to biometric sensor data to the ML accelerator; (II) restrict access to biometric templates to the subsystem.

In some embodiments, the main SoC is replaced with another type of system or control circuitry. In some embodiments, the companion SoC is replaced with another type of system or control circuitry. In some embodiments, the subsystem comprises a root-of-trust subsystem. In some embodiments, the ML accelerator comprises a deep learning accelerator. In some embodiments, generating validated sensor data comprises applying a frame quality model. In some embodiments, the firewall is configured to restrict access to biometric sensor data to only the ML accelerator.

In some embodiments, the firewall restricts access to biometric sensor data such that components other than the ML accelerator are prevented from accessing the biometric sensor data. In some embodiments, the main SoC is restricted from accessing raw biometric sensor data. In some embodiments, subsystems of the companion SoC other than the ML accelerator do not have access to biometric sensor data. In some embodiments, the firewall prevents general-purpose processors from accessing biometric sensor data.

In some embodiments, the firewall restricts access to stored biometric templates such that components other than the subsystem are prevented from accessing the stored biometric templates. In some embodiments, the ML accelerator does not have direct access to stored biometric templates. In some embodiments, the main SoC is restricted from accessing stored biometric templates. In some embodiments, biometric templates are inaccessible to subsystems other than the subsystem.

(E2) In some embodiments of E1, the subsystem is configured to derive cryptographic keys for secure communication with the main SoC. In some embodiments, the cryptographic keys are derived using a hardware random number generator included within the subsystem. In some embodiments, the derived cryptographic keys are stored in one-time programmable memory that is accessible only to trusted security firmware. In some embodiments, the subsystem derives application-specific keys through key derivation functions using a hardware-protected root key as input. In some embodiments, separate keys are derived for different operations including secure boot verification, biometric template encryption, and authenticated communication. In some embodiments, the cryptographic keys enable message authenticity and integrity verification through HMAC operations with nonce values. In some embodiments, the derived keys are used to establish shared secrets for secure IPC channels between the companion SoC and the main SoC. In some embodiments, the key derivation process occurs during a secure provisioning process at manufacturing time. In some embodiments, the subsystem maintains a key hierarchy where a root key is used to derive multiple subordinate keys for different security domains.

(E3) In some embodiments of E1 or E2, the companion SoC further comprises a component configured to route communication between the subsystem and the ML accelerator. In some embodiments, the component comprises a message dispatch component that routes IPC messages through ring buffers in shared memory. In some embodiments, the component comprises a frame manager control unit that coordinates message routing and camera scheduling. In some embodiments, the component routes communication through mailboxes implemented as ring buffers allocated in dedicated shared memory regions. In some embodiments, the component provides asynchronous communication between the subsystem and the ML accelerator while maintaining data integrity. In some embodiments, the component manages workload coordination across multiple subsystems through secure shared memory regions. In some embodiments, the component implements flow control mechanisms to prevent buffer overflow during high-throughput biometric processing operations. In some embodiments, the component schedules camera operations to coordinate sensor data capture with biometric processing workflows.

(E4) In some embodiments of any of E1-E3, the ML accelerator comprises: (i) the ML model configured to validate the received sensor data meets quality criteria; and (ii) a signature generation model configured to extract identifying features from validated sensor data. In some embodiments, the quality criteria include image clarity, positioning, lighting conditions, and biometric feature visibility. In some embodiments, the ML model checks that the biometric feature is in frame, in focus, and represents a live subject. In some embodiments, if the sensor data is invalid, the frame is discarded and a reason for discarding may be communicated through a callback mechanism. In some embodiments, the signature generation model extracts salient features from a biometric region that uniquely and persistently identify a single user. In some embodiments, the ML accelerator utilizes specialized hardware blocks optimized for biometric processing computational patterns including dedicated matrix multiplication units. In some embodiments, the ML accelerator implements reduced precision arithmetic with configurable bit widths for improved power efficiency. In some embodiments, the ML accelerator employs weight stationary dataflow that keeps model parameters local to processing elements. In some embodiments, the signature generation model produces a fixed-length feature vector that serves as a compact representation of the user’s biometric characteristics.

(E5) In some embodiments of any of E1-E4, the firewall is further configured to: (i) restrict access to the one or more ML models to only the ML accelerator and the subsystem; and (ii) restrict access to sensor calibration data. In some embodiments, the firewall is implemented through programmable lookup tables at network interfaces that specify allowed initiators, targets, and access types for each memory region. In some embodiments, the lookup tables are programmed by the subsystem during secure boot. In some embodiments, each transaction is checked against the lookup tables before proceeding through the network-on-chip. In some embodiments, the firewall implements separate read and write permissions with configurable address ranges. In some embodiments, the sensor calibration data is encrypted such that the plaintext is only visible to authenticated companion SoC software with a legitimate need to access the data. In some embodiments, the firewall restricts access to raw sensor frames to only a computer vision subsystem and the ML accelerator. In some embodiments, the firewall enforces access control at the transaction level for all data transfers within the companion SoC.

In some embodiments, the firewall restricts access to the one or more ML models such that components other than the ML accelerator and the subsystem are prevented from accessing the ML models. In some embodiments, the main SoC does not have access to plaintext ML models. In some embodiments, ML models are inaccessible to subsystems that do not have a legitimate need to access the models. In some embodiments, the firewall prevents unauthorized subsystems from reading or executing ML models. In some embodiments, the ML models are encrypted with a key specific to the intended subsystem, and decryption occurs only within authorized components. In some embodiments, the firewall logs access attempts to ML models for security auditing purposes. In some embodiments, the firewall blocks access requests from subsystems not included in an authorized access list configured during secure boot.

(E6) In some embodiments of any of E1-E5, the subsystem comprises: (i) a rate limiter configured to throttle authentication attempts; and (ii) a secure storage for the encrypted biometric templates, wherein the encrypted biometric templates are encrypted with a hardware-protected device-specific key. In some embodiments, the rate limiter is configured to throttle authentication attempts in order to prevent brute force attacks. In some embodiments, the rate limiter is implemented through a token bucket algorithm where each authentication attempt consumes a token. In some embodiments, the system replenishes tokens at a configured rate and maintains separate buckets for different types of authentication operations. In some embodiments, when the token bucket is empty, the system enforces a mandatory waiting period before allowing additional attempts. In some embodiments, the rate limiter limits authentication attempts to a predetermined number per time period. In some embodiments, the secure storage is accessible only to the subsystem and is encrypted with a hardware-protected, device-generated key. In some embodiments, the biometric templates stored in secure storage include computed signatures that are persisted over time and used as the basis for comparison during authentication attempts. In some embodiments, the secure storage also stores intermediate working products that may include user data in raw or processed form. In some embodiments, the rate limiter maintains a count of consecutive failed authentication attempts and triggers additional security measures after the count exceeds a configurable threshold.

(E7) In some embodiments of any of E1-E6, the companion SoC further comprises: (i) a second subsystem configured to preprocess raw sensor data before ML processing, (ii) wherein the firewall is configured to allow the second subsystem access to raw sensor data. In some embodiments, the second subsystem is a computer vision subsystem. In some embodiments, the second subsystem comprises a computer vision digital signal processor. In some embodiments, the second subsystem runs a signature state machine that routes sensor frames to the appropriate ML model, routes biometric signatures to the subsystem, and gracefully handles errors. In some embodiments, the second subsystem performs frame preprocessing on raw sensor frames before providing them to the ML accelerator. In some embodiments, the preprocessing includes noise reduction, contrast enhancement, or geometric normalization of the sensor data. In some embodiments, the second subsystem validates that sensor data meets minimum quality thresholds before forwarding to the ML accelerator.

In some embodiments, the firewall allows the second subsystem access to raw sensor data while restricting access by other subsystems. In some embodiments, raw sensor data is accessible to the computer vision subsystem and the ML accelerator but inaccessible to the main SoC. In some embodiments, the firewall permits the second subsystem to read raw sensor data while preventing write access by unauthorized components. In some embodiments, subsystems other than the computer vision subsystem and the ML accelerator are prevented from accessing raw sensor data. In some embodiments, the firewall implements memory protection units that restrict read and write access to sensor data buffers based on the identity of the requesting subsystem. In some embodiments, sensor data paths are implemented as point-to-point connections protected by the network-on-chip firewall. In some embodiments, sensor data buffers are implemented in dedicated memory regions with hardware-enforced access restrictions.

(E8) In some embodiments of any of E1-E7, the companion Soc is configured to: (i) load at least one of the one or more ML models based on authentication requests; and (ii) maintain separate secure memory regions for template storage and model execution. In some embodiments, the one or more ML models are loaded dynamically. In some embodiments, the companion SoC loads different ML models depending on the type of biometric authentication being performed. In some embodiments, the companion SoC verifies authenticity of ML models before loading by checking digital signatures and performing anti-rollback checks. In some embodiments, the companion SoC decrypts ML models using a key accessible only within the companion SoC before loading into execution memory. In some embodiments, the separate secure memory regions are protected by memory protection units that enforce access restrictions based on subsystem identity. In some embodiments, template storage memory regions are accessible only to the subsystem while model execution memory regions are accessible to the ML accelerator. In some embodiments, the companion SoC clears model execution memory regions after authentication operations complete to prevent residual data exposure.

(E9) In some embodiments of any of E1-E8, the system further comprises a control unit configured to coordinate workloads across subsystems through secure shared memory regions. In accordance with some embodiments, the control unit comprises a message control unit. In some embodiments, the control unit comprises a frame manager control unit that routes inter-process communication messages between the subsystem, a computer vision subsystem, and the ML accelerator. In some embodiments, the control unit implements message routing through ring buffers allocated in shared memory. In some embodiments, the shared memory regions are partitioned into separate blocks dedicated to different types of data including control signals, raw sensor data, and processed biometric signatures. In some embodiments, the control unit schedules camera operations to coordinate sensor data capture with biometric processing. In some embodiments, the control unit manages power state transitions for subsystems based on authentication workload requirements. In some embodiments, the control unit implements priority-based scheduling to ensure time-sensitive authentication operations complete within latency requirements.

(E10) In some embodiments of any of E1-E9, the companion SoC is configured to: (i) process biometric sensor data; (ii) generate a signed authentication result message with a freshness indicator; and (iii) transmit the signed authentication result message to the main SoC, wherein the biometric sensor data is not transmitted to the main SoC. In some embodiments, the companion SoC is configured to process biometric sensor data entirely within the companion SoC. In some embodiments, the companion SoC is configured to only transmit the signed authentication result message to the main SoC, wherein raw biometric data remains within the companion SoC. In some embodiments, the freshness indicator comprises a nonce to prevent replay attacks. In some embodiments, the signed authentication result message includes a message authentication code generated using keys derived during manufacturing. In some embodiments, the authentication result message indicates a pass or fail status without revealing any information about the biometric data or matching score. In some embodiments, intermediate processing results including extracted features and similarity scores remain within the companion SoC and are not accessible to the main SoC. In some embodiments, the companion SoC transmits the authentication result through an authenticated and replay-resistant secure IPC channel. In some embodiments, the companion SoC invalidates or clears biometric sensor data from memory after authentication processing completes.

In some embodiments, the companion SoC processes biometric sensor data without transmitting the biometric sensor data to the main SoC. In some embodiments, biometric sensor data processing occurs within the companion SoC and does not occur within the main SoC. In some embodiments, the main SoC does not receive or process raw biometric sensor data. In some embodiments, biometric sensor data is confined to the companion SoC during processing.

In some embodiments, the companion SoC transmits the signed authentication result message to the main SoC without transmitting raw biometric data. In some embodiments, the signed authentication result message is the sole biometric-related data transmitted from the companion SoC to the main SoC. In some embodiments, raw biometric data and intermediate processing results are not transmitted to the main SoC. In some embodiments, the main SoC receives authentication results but does not receive biometric sensor data or biometric templates.

(F1) In another aspect, some embodiments include a method of securely processing biometric sensor data. The method comprises: (i) encrypting a set of ML models using a subsystem of a wearable device that is isolated from a main SoC of the wearable device; (ii) storing, via the subsystem, encrypted biometric templates, wherein access to the encrypted biometric templates is restricted to the subsystem; (iii) verifying, using the subsystem, authenticity of an ML model from the set of ML models prior to use of the ML model; (iv) validating biometric sensor data by applying the ML model using an ML accelerator of the wearable device, wherein access to the biometric sensor data is restricted to the ML accelerator; (v) generating, via the ML accelerator, a biometric signature from validated biometric sensor data, wherein the biometric signature is generated using at least one ML model of the set of ML models; and (vi) authentication, using the subsystem, the biometric signature against stored encrypted biometric templates.

In some embodiments, the main SoC is replaced with another type of system or control circuitry. In some embodiments, the companion SoC is replaced with another type of system or control circuitry. In some embodiments, the subsystem comprises a root-of-trust subsystem. In some embodiments, the ML accelerator comprises a deep learning accelerator. In some embodiments, generating validated sensor data comprises applying a frame quality model. In some embodiments, the firewall is configured to restrict access to biometric sensor data to only the ML accelerator.

(F2) In some embodiments of F1, the method further comprises deriving, via the subsystem, cryptographic keys for secure communication with the main SoC. In some embodiments, the cryptographic keys are derived during a secure provisioning process. In some embodiments, deriving the cryptographic keys comprises generating a device root key using a hardware random number generator. In some embodiments, the derived cryptographic keys are used to establish authenticated communication channels between the companion SoC and the main SoC. In some embodiments, the method further comprises deriving application-specific keys from a root key using key derivation functions. In some embodiments, separate cryptographic keys are derived for different security operations including template encryption, model verification, and inter-processor communication. In some embodiments, the derived keys enable generation of message authentication codes for verifying data integrity during communication with the main SoC.

(F3) In some embodiments of F1 or F2, the method further comprises routing communication between the subsystem and the ML accelerator through one or more ring buffers in shared memory. In some embodiments, routing communication between the subsystem and the ML accelerator is routed via a message dispatch component. In some embodiments, the ring buffers implement asynchronous message passing between the subsystem and the ML accelerator. In some embodiments, the shared memory comprises multiple dedicated memory blocks allocated for different types of inter-process communication. In some embodiments, the method further comprises implementing flow control mechanisms within the ring buffers to prevent data overflow during high-throughput biometric processing. In some embodiments, the message dispatch component coordinates scheduling of camera operations in addition to routing messages. In some embodiments, the ring buffers maintain separate queues for control messages and data payloads. In some embodiments, the method further comprises validating message integrity before processing messages retrieved from the ring buffers.

(F4) In some embodiments of any of F1-F3, the method further comprises validating the biometric sensor data comprises determining whether the biometric sensor data meets one or more quality criteria and generating the biometric signature comprises extracting, using a second ML model of the set of ML models, identifying features from validated biometric sensor data. In some embodiments, the quality criteria include at least one of image clarity, biometric feature positioning, lighting conditions, and focus quality. In some embodiments, validating the biometric sensor data comprises determining whether a biometric feature is present within a captured frame. In some embodiments, the method further comprises discarding biometric sensor data that fails to meet the quality criteria and providing feedback indicating a reason for discarding. In some embodiments, the identifying features extracted by the second ML model comprise a fixed-length feature vector that uniquely represents a user’s biometric characteristics. In some embodiments, the method further comprises applying liveness detection to the biometric sensor data to verify the biometric data originates from a live subject. In some embodiments, the second ML model extracts features that are invariant to minor changes in user appearance over time.

(F5) In some embodiments of any of F1-F4, the method further comprises: (i) restricting, via the firewall, access to the one or more ML models to only the ML accelerator and the subsystem; and (ii) restricting, via the firewall, access to sensor calibration data. In some embodiments, restricting access comprises configuring programmable access control entries at network interface points within the companion SoC. In some embodiments, the firewall enforces separate read and write permissions for different memory regions. In some embodiments, the method further comprises logging access attempts to restricted resources for security auditing purposes. In some embodiments, restricting access to sensor calibration data comprises encrypting the calibration data such that only authorized subsystems can decrypt and access the plaintext. In some embodiments, the firewall blocks access requests from subsystems not included in an authorized access list. In some embodiments, the method further comprises restricting access to intermediate processing results generated during biometric signature computation.

(F6) In some embodiments of any of F1-F5, wherein the subsystem further comprises a rate limiter configured to throttle authentication attempts. In some embodiments, the rate limiter implements a token bucket algorithm where each authentication attempt consumes a token from a bucket that is replenished at a configured rate. In some embodiments, the rate limiter maintains separate token buckets for different types of authentication operations. In some embodiments, the method further comprises enforcing a mandatory waiting period when the rate limit is exceeded before allowing additional authentication attempts. In some embodiments, the rate limiter tracks consecutive failed authentication attempts and triggers additional security measures after a configurable threshold is exceeded. In some embodiments, the rate limiter stores token counts in secure memory with integrity protection. In some embodiments, the method further comprises resetting the rate limiter state upon successful authentication by an alternative authentication method.

(F7) In some embodiments of any of F1-F6, the method further comprises encrypting the encrypted biometric templates using a hardware-protected device-specific key. In some embodiments, the hardware-protected device-specific key is stored in one-time programmable memory that is accessible only to the subsystem. In some embodiments, the method further comprises generating the device-specific key during a secure manufacturing provisioning process. In some embodiments, encrypting the biometric templates comprises applying authenticated encryption that provides both confidentiality and integrity protection. In some embodiments, the method further comprises periodically re-encrypting stored templates using updated key material. In some embodiments, the hardware-protected key is derived from a root key using a key derivation function with device-specific parameters. In some embodiments, the method further comprises securely erasing plaintext biometric data from memory after encryption is complete.

(F8) In some embodiments of any of F1-F7, the companion SoC further comprises: (i) a second subsystem configured to preprocess raw sensor data before ML processing, (ii) wherein the firewall is configured to allow the second subsystem access to raw sensor data. In some embodiments, the second subsystem comprises a digital signal processor optimized for computer vision operations. In some embodiments, preprocessing raw sensor data comprises performing noise reduction, contrast enhancement, or geometric normalization. In some embodiments, the second subsystem validates that sensor data meets minimum quality thresholds before forwarding to the ML accelerator. In some embodiments, the second subsystem shares access to a sensor data stream with other functions operating on the companion SoC. In some embodiments, the method further comprises configuring memory protection units to restrict access to raw sensor data to only the second subsystem and the ML accelerator. In some embodiments, the second subsystem implements a state machine that routes sensor frames to appropriate processing stages and handles error conditions.

(F9) In some embodiments of any of F1-F8, the method further comprises: via the companion SoC: (i) loading at least one of the one or more ML models based on authentication requests; and (ii) maintaining separate secure memory regions for template storage and model execution. In some embodiments, loading the ML models comprises verifying digital signatures attached to model files before loading. In some embodiments, the method further comprises performing an anti-rollback check to confirm that an ML model has not been replaced with an earlier version. In some embodiments, the ML models are decrypted using a key accessible only within the companion SoC before loading into execution memory. In some embodiments, the method further comprises clearing model execution memory regions after authentication operations complete to prevent residual data exposure. In some embodiments, different ML models are loaded depending on the type of biometric authentication being performed. In some embodiments, the separate secure memory regions are protected by hardware-enforced access restrictions based on subsystem identity.

(F10) In some embodiments of any of F1-F9, the method further comprises coordinating, via a control unit, workloads across subsystems through secure shared memory regions. In some embodiments, the control unit comprises a frame manager control unit that routes inter-process communication messages between multiple subsystems. In some embodiments, the control unit schedules sensor capture operations to coordinate with biometric processing workflows. In some embodiments, the method further comprises implementing priority-based scheduling to ensure time-sensitive authentication operations complete within latency requirements. In some embodiments, the control unit manages power state transitions for subsystems based on authentication workload requirements. In some embodiments, the secure shared memory regions are partitioned into separate blocks dedicated to different types of data including control signals, sensor data, and processed signatures. In some embodiments, the control unit implements handshaking protocols to synchronize data transfers between subsystems operating at different processing rates.

(F11) In some embodiments of any of F1-F10, the method further comprises, via the companion SoC: (i) processing biometric sensor data; (ii) generating a signed authentication result message with a freshness indicator; and (iii) transmitting the signed authentication result message to the main SoC, wherein the biometric sensor data is not transmitted to the main SoC. In some embodiments, the freshness indicator comprises a nonce value that prevents replay attacks. In some embodiments, the signed authentication result message includes a message authentication code generated using keys derived during manufacturing. In some embodiments, the authentication result message indicates a pass or fail status without revealing information about the biometric data or matching score. In some embodiments, intermediate processing results including extracted features and similarity scores remain within the companion SoC and are not accessible to the main SoC. In some embodiments, the method further comprises transmitting the authentication result through a secure inter-process communication channel that provides both authentication and replay resistance. In some embodiments, the method further comprises invalidating or clearing biometric sensor data from memory within the companion SoC after authentication processing completes. In some embodiments, the signed authentication result message is the sole biometric-related data transmitted from the companion SoC to the main SoC during an authentication operation.

As can be appreciated by one of ordinary skill in the art, the methods and techniques described herein (e.g., B1-B3, C1-C6, D1-D2, E1-E10, and F1-F11) can be combined with one another and/or rearranged in various configurations. In accordance with some embodiments, a method of operating a computing system includes operations that correspond to any of the methods and techniques described herein (e.g., B1-B3, C1-C6, D1-D2, E1-E10, and F1-F11).

In accordance with some embodiments, a computing system is configured to perform operations corresponding to any of the methods described herein (e.g., B1-B3, C1-C6, D1-D2, E1-E10, and F1-F11). The computing system may include any of the devices described herein, including but not limited to one or more wrist-wearable devices, a pair of augmented-reality glasses, an MR headset, an HIPD, a smart textile-based garment, and/or other electronic devices described herein. The main SoC and/or the companion SoC described herein may be integrated within or otherwise form part of such devices.

In accordance with some embodiments, a non-transitory computer-readable storage medium stores instructions that, when executed by a computing system, cause the computing system to perform operations corresponding to any of the methods and techniques described herein (e.g., B1-B3, C1-C6, D1-D2, E1-E10, and F1-F11). The computing system may include or be in communication with any of the devices described herein, such as any of the devices described in the following sections. In some embodiments, the main SoC and/or the companion SoC described previously are components of one of the devices described below.

### Example Extended-Reality Systems

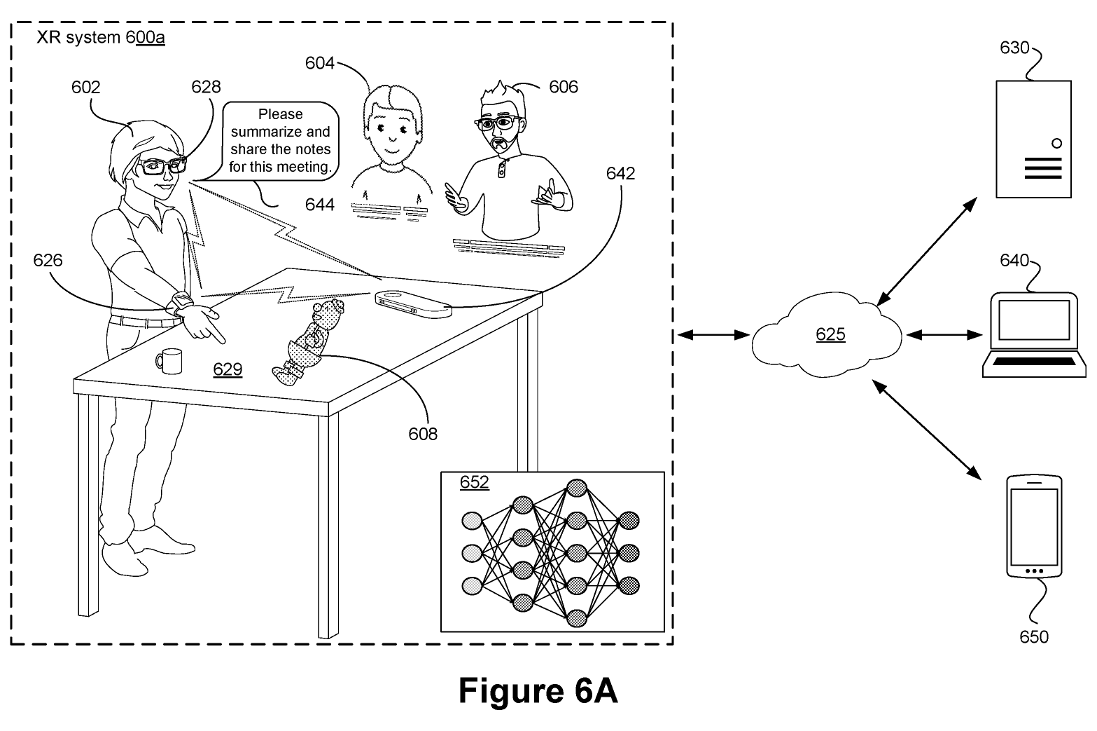

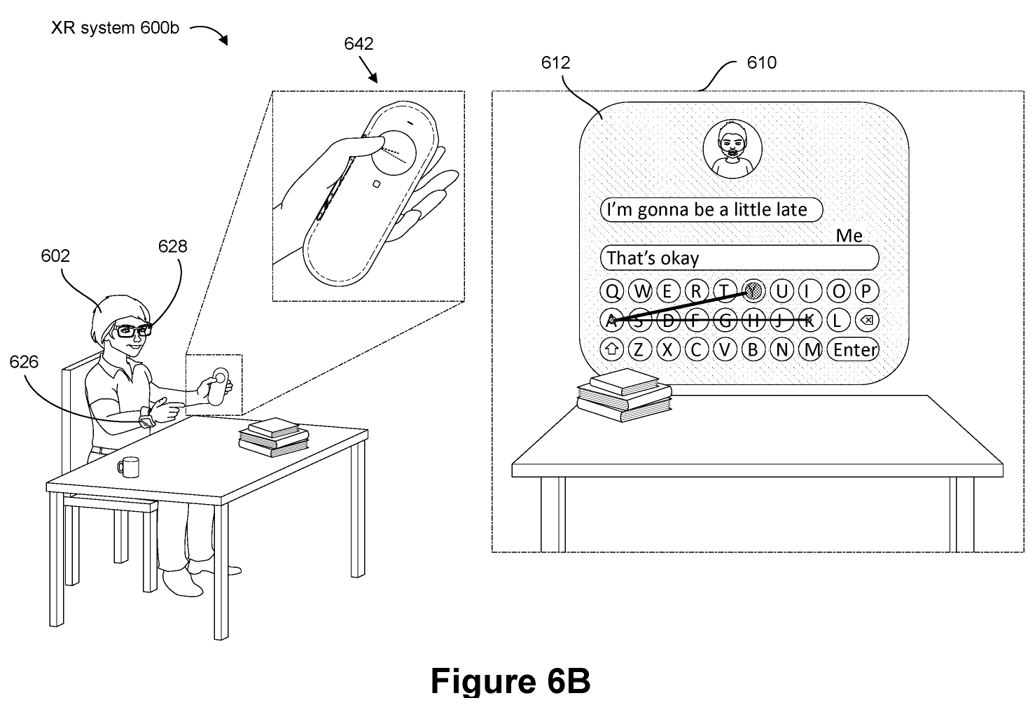

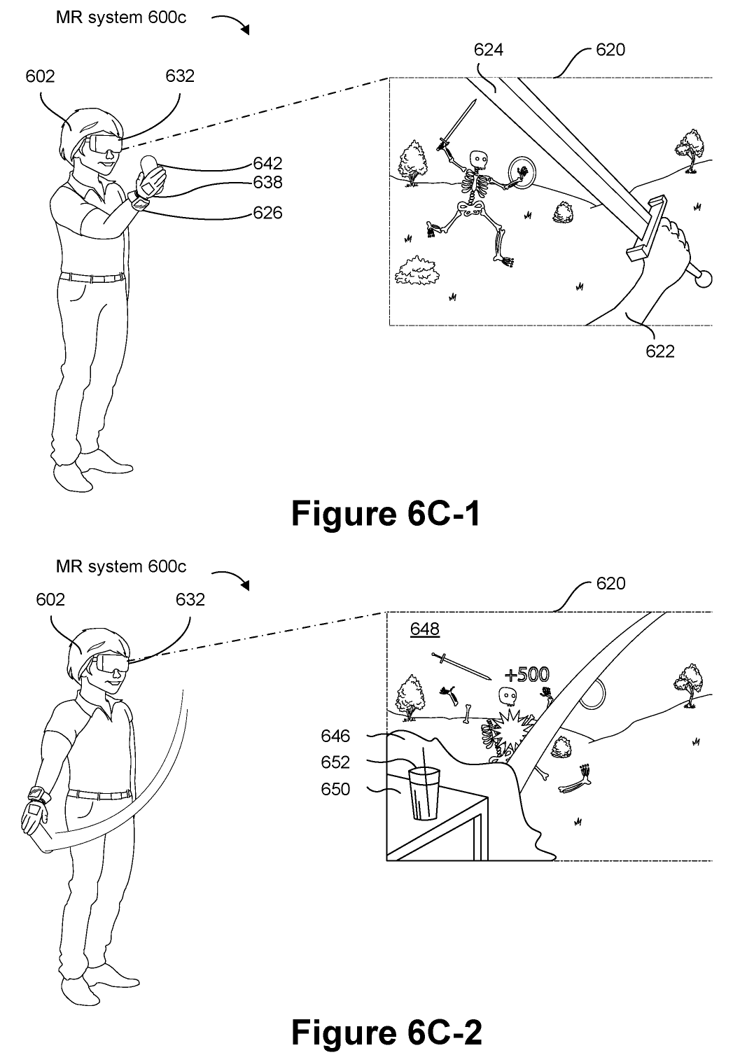

FIGS. 6A, 6B, 6C-1, and 6C-2, illustrate example XR systems that include AR and MR systems, in accordance with some embodiments. FIG. 6A shows a first XR system 600a and first example user interactions using a wrist-wearable device 626, a head-wearable device (e.g., AR device 628), and/or a HIPD 642. FIG. 6B shows a second XR system 600b and second example user interactions using a wrist-wearable device 626, AR device 628, and/or an HIPD 642. FIGS. 6C-1 and 6C-2 show a third MR system 600c and third example user interactions using a wrist-wearable device 626, a head-wearable device (e.g., an MR device such as a VR device), and/or an HIPD 642. As the skilled artisan will appreciate upon reading the descriptions provided herein, the above-example AR and MR systems (described in detail below) can perform various functions and/or operations.

The wrist-wearable device 626, the head-wearable devices, and/or the HIPD 642 can communicatively couple via a network 625 (e.g., cellular, near field, Wi-Fi, personal area network, wireless LAN). Additionally, the wrist-wearable device 626, the head-wearable device, and/or the HIPD 642 can also communicatively couple with one or more servers 630, computers 640 (e.g., laptops, computers), mobile devices 650 (e.g., smartphones, tablets), and/or other electronic devices via the network 625 (e.g., cellular, near field, Wi-Fi, personal area network, wireless LAN). Similarly, a smart textile-based garment, when used, can also communicatively couple with the wrist-wearable device 626, the head-wearable device(s), the HIPD 642, the one or more servers 630, the computers 640, the mobile devices 650, and/or other electronic devices via the network 625 to provide inputs.

Turning to FIG. 6A, a user 602 is shown wearing the wrist-wearable device 626 and the AR device 628 and having the HIPD 642 on their desk. The wrist-wearable device 626, the AR device 628, and the HIPD 642 facilitate user interaction with an AR environment. In particular, as shown by the first AR system 600a, the wrist-wearable device 626, the AR device 628, and/or the HIPD 642 cause presentation of one or more avatars 604, digital representations of contacts 606, and virtual objects 608. As discussed below, the user 602 can interact with the one or more avatars 604, digital representations of the contacts 606, and virtual objects 608 via the wrist-wearable device 626, the AR device 628, and/or the HIPD 642. In addition, the user 602 is also able to directly view physical objects in the environment, such as a physical table 629, through transparent lens(es) and waveguide(s) of the AR device 628. Alternatively, an MR device could be used in place of the AR device 628 and a similar user experience can take place, but the user would not be directly viewing physical objects in the environment, such as table 629, and would instead be presented with a virtual reconstruction of the table 629 produced from one or more sensors of the MR device (e.g., an outward facing camera capable of recording the surrounding environment).

The user 602 can use any of the wrist-wearable device 626, the AR device 628 (e.g., through physical inputs at the AR device and/or built-in motion tracking of a user’s extremities), a smart-textile garment, externally mounted extremity tracking device, the HIPD 642 to provide user inputs, etc. For example, the user 602 can perform one or more hand gestures that are detected by the wrist-wearable device 626 (e.g., using one or more EMG sensors and/or IMUs built into the wrist-wearable device) and/or AR device 628 (e.g., using one or more image sensors or cameras) to provide a user input. Alternatively, or additionally, the user 602 can provide a user input via one or more touch surfaces of the wrist-wearable device 626, the AR device 628, and/or the HIPD 642, and/or voice commands captured by a microphone of the wrist-wearable device 626, the AR device 628, and/or the HIPD 642. The wrist-wearable device 626, the AR device 628, and/or the HIPD 642 include an artificially intelligent digital assistant to help the user in providing a user input (e.g., completing a sequence of operations, suggesting different operations or commands, providing reminders, confirming a command). For example, the digital assistant can be invoked through an input occurring at the AR device 628 (e.g., via an input at a temple arm of the AR device 628). In some embodiments, the user 602 can provide a user input via one or more facial gestures and/or facial expressions. For example, cameras of the wrist-wearable device 626, the AR device 628, and/or the HIPD 642 can track the user 602’s eyes for navigating a user interface.

The wrist-wearable device 626, the AR device 628, and/or the HIPD 642 can operate alone or in conjunction to allow the user 602 to interact with the AR environment. In some embodiments, the HIPD 642 is configured to operate as a central hub or control center for the wrist-wearable device 626, the AR device 628, and/or another communicatively coupled device. For example, the user 602 can provide an input to interact with the AR environment at any of the wrist-wearable device 626, the AR device 628, and/or the HIPD 642, and the HIPD 642 can identify one or more back-end and front-end tasks to cause the performance of the requested interaction and distribute instructions to cause the performance of the one or more back-end and front-end tasks at the wrist-wearable device 626, the AR device 628, and/or the HIPD 642. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 642 can perform the back-end tasks and provide the wrist-wearable device 626 and/or the AR device 628 operational data corresponding to the performed back-end tasks such that the wrist-wearable device 626 and/or the AR device 628 can perform the front-end tasks. In this way, the HIPD 642, which has more computational resources and greater thermal headroom than the wrist-wearable device 626 and/or the AR device 628, performs computationally intensive tasks and reduces the computer resource utilization and/or power usage of the wrist-wearable device 626 and/or the AR device 628.

In the example shown by the first AR system 600a, the HIPD 642 identifies one or more back-end tasks and front-end tasks associated with a user request to initiate an AR video call with one or more other users (represented by the avatar 604 and the digital representation of the contact 606) and distributes instructions to cause the performance of the one or more back-end tasks and front-end tasks. In particular, the HIPD 642 performs back-end tasks for processing and/or rendering image data (and other data) associated with the AR video call and provides operational data associated with the performed back-end tasks to the AR device 628 such that the AR device 628 performs front-end tasks for presenting the AR video call (e.g., presenting the avatar 604 and the digital representation of the contact 606).

In some embodiments, the HIPD 642 can operate as a focal or anchor point for causing the presentation of information. This allows the user 602 to be generally aware of where information is presented. For example, as shown in the first AR system 600a, the avatar 604 and the digital representation of the contact 606 are presented above the HIPD 642. In particular, the HIPD 642 and the AR device 628 operate in conjunction to determine a location for presenting the avatar 604 and the digital representation of the contact 606. In some embodiments, information can be presented within a predetermined distance from the HIPD 642 (e.g., within five meters). For example, as shown in the first AR system 600a, virtual object 608 is presented on the desk some distance from the HIPD 642. Similar to the above example, the HIPD 642 and the AR device 628 can operate in conjunction to determine a location for presenting the virtual object 608. Alternatively, in some embodiments, presentation of information is not bound by the HIPD 642. More specifically, the avatar 604, the digital representation of the contact 606, and the virtual object 608 do not have to be presented within a predetermined distance of the HIPD 642. While an AR device 628 is described working with an HIPD, an MR headset can be interacted with in the same way as the AR device 628.

User inputs provided at the wrist-wearable device 626, the AR device 628, and/or the HIPD 642 are coordinated such that the user can use any device to initiate, continue, and/or complete an operation. For example, the user 602 can provide a user input to the AR device 628 to cause the AR device 628 to present the virtual object 608 and, while the virtual object 608 is presented by the AR device 628, the user 602 can provide one or more hand gestures via the wrist-wearable device 626 to interact and/or manipulate the virtual object 608. While an AR device 628 is described working with a wrist-wearable device 626, an MR headset can be interacted with in the same way as the AR device 628.

### Integration of Artificial Intelligence with XR Systems

FIG. 6A illustrates an interaction in which an artificially intelligent virtual assistant can assist in requests made by a user 602. The AI virtual assistant can be used to complete open-ended requests made through natural language inputs by a user 602. For example, in FIG. 6A the user 602 makes an audible request 644 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 6A also illustrates an example neural network 652 used in Artificial Intelligence applications. Uses of Artificial Intelligence (AI) are varied and encompass many different aspects of the devices and systems described herein. AI capabilities cover a diverse range of applications and deepen interactions between the user 602 and user devices (e.g., the AR device 628, an MR device 632, the HIPD 642, the wrist-wearable device 626). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user’s request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 602 can interact with an AI model through natural language inputs captured by a voice sensor, text inputs, or any other input modality that accepts natural language and/or a corresponding voice sensor module. In another instance, input is provided by tracking the eye gaze of a user 602 via a gaze tracker module. Additionally, the AI model can also receive inputs beyond those supplied by a user 602. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors’ data can be retrieved entirely from a single device (e.g., AR device 628) or from multiple devices that are in communication with each other (e.g., a system that includes at least two of an AR device 628, an MR device 632, the HIPD 642, the wrist-wearable device 626, etc.). The AI model can also access additional information (e.g., one or more servers 630, the computers 640, the mobile devices 650, and/or other electronic devices) via a network 625.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 628, an MR device 632, the HIPD 642, the wrist-wearable device 626) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 628, an MR device 632, the HIPD 642, the wrist-wearable device 626), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 642), haptic feedback can provide information to the user 602. An AI model can also use the inputs described above to determine the appropriate modality and device(s) to present content to the user (e.g., a user walking on a busy road can be presented with an audio output instead of a visual output to avoid distracting the user 602).

### Example Augmented Reality Interaction

FIG. 6B shows the user 602 wearing the wrist-wearable device 626 and the AR device 628 and holding the HIPD 642. In the second AR system 600b, the wrist-wearable device 626, the AR device 628, and/or the HIPD 642 are used to receive and/or provide one or more messages to a contact of the user 602. In particular, the wrist-wearable device 626, the AR device 628, and/or the HIPD 642 detect and coordinate one or more user inputs to initiate a messaging application and prepare a response to a received message via the messaging application.

In some embodiments, the user 602 initiates, via a user input, an application on the wrist-wearable device 626, the AR device 628, and/or the HIPD 642 that causes the application to initiate on at least one device. For example, in the second AR system 600b the user 602 performs a hand gesture associated with a command for initiating a messaging application (represented by messaging user interface 612); the wrist-wearable device 626 detects the hand gesture; and, based on a determination that the user 602 is wearing the AR device 628, causes the AR device 628 to present a messaging user interface 612 of the messaging application. The AR device 628 can present the messaging user interface 612 to the user 602 via its display (e.g., as shown by user 602’s field of view 610). In some embodiments, the application is initiated and can be run on the device (e.g., the wrist-wearable device 626, the AR device 628, and/or the HIPD 642) that detects the user input to initiate the application, and the device provides another device operational data to cause the presentation of the messaging application. For example, the wrist-wearable device 626 can detect the user input to initiate a messaging application, initiate and run the messaging application, and provide operational data to the AR device 628 and/or the HIPD 642 to cause presentation of the messaging application. Alternatively, the application can be initiated and run at a device other than the device that detected the user input. For example, the wrist-wearable device 626 can detect the hand gesture associated with initiating the messaging application and cause the HIPD 642 to run the messaging application and coordinate the presentation of the messaging application.

Further, the user 602 can provide a user input provided at the wrist-wearable device 626, the AR device 628, and/or the HIPD 642 to continue and/or complete an operation initiated at another device. For example, after initiating the messaging application via the wrist-wearable device 626 and while the AR device 628 presents the messaging user interface 612, the user 602 can provide an input at the HIPD 642 to prepare a response (e.g., shown by the swipe gesture performed on the HIPD 642). The user 602’s gestures performed on the HIPD 642 can be provided and/or displayed on another device. For example, the user 602’s swipe gestures performed on the HIPD 642 are displayed on a virtual keyboard of the messaging user interface 612 displayed by the AR device 628.

In some embodiments, the wrist-wearable device 626, the AR device 628, the HIPD 642, and/or other communicatively coupled devices can present one or more notifications to the user 602. The notification can be an indication of a new message, an incoming call, an application update, a status update, etc. The user 602 can select the notification via the wrist-wearable device 626, the AR device 628, or the HIPD 642 and cause presentation of an application or operation associated with the notification on at least one device. For example, the user 602 can receive a notification that a message was received at the wrist-wearable device 626, the AR device 628, the HIPD 642, and/or other communicatively coupled device and provide a user input at the wrist-wearable device 626, the AR device 628, and/or the HIPD 642 to review the notification, and the device detecting the user input can cause an application associated with the notification to be initiated and/or presented at the wrist-wearable device 626, the AR device 628, and/or the HIPD 642.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 628 can present to the user 602 game application data and the HIPD 642 can use a controller to provide inputs to the game. Similarly, the user 602 can use the wrist-wearable device 626 to initiate a camera of the AR device 628, and the user can use the wrist-wearable device 626, the AR device 628, and/or the HIPD 642 to manipulate the image capture (e.g., zoom in or out, apply filters) and capture image data.

While an AR device 628 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user’s hand or other suitable surface (e.g., a table, whiteboard). In yet another embodiment, information may also be provided by locally dimming portions of a lens to emphasize portions of the environment in which the user’s attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 6C-1 and 6C-2, the user 602 is shown wearing the wrist-wearable device 626 and an MR device 632 (e.g., a device capable of providing either an entirely VR experience or an MR experience that displays object(s) from a physical environment at a display of the device) and holding the HIPD 642. In the third AR system 600c, the wrist-wearable device 626, the MR device 632, and/or the HIPD 642 are used to interact within an MR environment, such as a VR game or other MR/VR application. While the MR device 632 presents a representation of a VR game (e.g., first MR game environment 620) to the user 602, the wrist-wearable device 626, the MR device 632, and/or the HIPD 642 detect and coordinate one or more user inputs to allow the user 602 to interact with the VR game.

In some embodiments, the user 602 can provide a user input via the wrist-wearable device 626, the MR device 632, and/or the HIPD 642 that causes an action in a corresponding MR environment. For example, the user 602 in the third MR system 600c (shown in FIG. 6C-1) raises the HIPD 642 to prepare for a swing in the first MR game environment 620. The MR device 632, responsive to the user 602 raising the HIPD 642, causes the MR representation of the user 622 to perform a similar action (e.g., raise a virtual object, such as a virtual sword 624). In some embodiments, each device uses respective sensor data and/or image data to detect the user input and provide an accurate representation of the user 602’s motion. For example, image sensors (e.g., SLAM cameras or other cameras) of the HIPD 642 can be used to detect a position of the HIPD 642 relative to the user 602’s body such that the virtual object can be positioned appropriately within the first MR game environment 620; sensor data from the wrist-wearable device 626 can be used to detect a velocity at which the user 602 raises the HIPD 642 such that the MR representation of the user 622 and the virtual sword 624 are synchronized with the user 602’s movements; and image sensors of the MR device 632 can be used to represent the user 602’s body, boundary conditions, or real-world objects within the first MR game environment 620.

In FIG. 6C-2, the user 602 performs a downward swing while holding the HIPD 642. The user 602’s downward swing is detected by the wrist-wearable device 626, the MR device 632, and/or the HIPD 642 and a corresponding action is performed in the first MR game environment 620. In some embodiments, the data captured by each device is used to improve the user’s experience within the MR environment. For example, sensor data of the wrist-wearable device 626 can be used to determine a speed and/or force at which the downward swing is performed and image sensors of the HIPD 642 and/or the MR device 632 can be used to determine a location of the swing and how it should be represented in the first MR game environment 620, which, in turn, can be used as inputs for the MR environment (e.g., game mechanics, which can use detected speed, force, locations, and/or aspects of the user 602’s actions to classify a user’s inputs (e.g., user performs a light strike, hard strike, critical strike, glancing strike, miss) or calculate an output (e.g., amount of damage)).

FIG. 6C-2 further illustrates that a portion of the physical environment is reconstructed and displayed at a display of the MR device 632 while the MR game environment 620 is being displayed. In this instance, a reconstruction of the physical environment 646 is displayed in place of a portion of the MR game environment 620 when object(s) in the physical environment are potentially in the path of the user (e.g., a collision with the user and an object in the physical environment are likely). Thus, this example MR game environment 620 includes (i) an immersive VR portion 648 (e.g., an environment that does not have a corollary counterpart in a nearby physical environment) and (ii) a reconstruction of the physical environment 646 (e.g., table 650 and cup 652). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 626, the MR device 632, and/or the HIPD 642 are described as detecting user inputs, in some embodiments, user inputs are detected at a single device (with the single device being responsible for distributing signals to the other devices for performing the user input). For example, the HIPD 642 can operate an application for generating the first MR game environment 620 and provide the MR device 632 with corresponding data for causing the presentation of the first MR game environment 620, as well as detect the user 602’s movements (while holding the HIPD 642) to cause the performance of corresponding actions within the first MR game environment 620. Additionally, or alternatively, in some embodiments, operational data (e.g., sensor data, image data, application data, device data, and/or other data) of one or more devices is provided to a single device (e.g., the HIPD 642) to process the operational data and cause respective devices to perform an action associated with processed operational data.

In some embodiments, the user 602 can wear a wrist-wearable device 626, wear an MR device 632, wear smart textile-based garments 638 (e.g., wearable haptic gloves), and/or hold an HIPD 642 device. In this embodiment, the wrist-wearable device 626, the MR device 632, and/or the smart textile-based garments 638 are used to interact within an MR environment (e.g., any AR or MR system described above in reference to FIGS. 6A–6B). While the MR device 632 presents a representation of an MR game (e.g., second MR game environment 620) to the user 602, the wrist-wearable device 626, the MR device 632, and/or the smart textile-based garments 638 detect and coordinate one or more user inputs to allow the user 602 to interact with the MR environment.

In some embodiments, the user 602 can provide a user input via the wrist-wearable device 626, an HIPD 642, the MR device 632, and/or the smart textile-based garments 638 that causes an action in a corresponding MR environment. In some embodiments, each device uses respective sensor data and/or image data to detect the user input and provide an accurate representation of the user 602’s motion. While four different input devices are shown (e.g., a wrist-wearable device 626, an MR device 632, an HIPD 642, and a smart textile-based garment 638) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 638) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user’s experience within the MR environment. Although not shown, the smart textile-based garments 638 can be used in conjunction with an MR device and/or an HIPD 642.

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 6A-6C-2 provided above are intended to augment the description provided in reference to FIGS. 1-5. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A system for biometric authentication in a wearable device comprising a main system-on-a-chip (SoC) and a companion SoC that is configured to operate with reduced area and reduced power consumption compared to the main SoC, the companion SoC comprising:
a machine-learning (ML) accelerator for biometric processing, wherein the ML accelerator is configured to:
generate validated sensor data by applying a biometric sensor data to an ML model, and
generate a biometric signature from the validated sensor data;
a subsystem isolated from general-purpose processing of the main SoC, wherein the subsystem is configured to:
store encrypted biometric templates,
authenticate the biometric signature against stored templates,
encrypt one or more ML models used by the ML accelerator, and
verify authenticity of the one or more ML models before use;
a network-on-chip (NoC) interconnecting the ML accelerator and subsystem; and
a firewall implemented in the network-on-chip configured to:
restrict access to biometric sensor data to the ML accelerator; and
restrict access to stored biometric templates to the subsystem.

2. The system of claim 1, wherein the subsystem is configured to derive cryptographic keys for secure communication with the main SoC.

3. The system of claim 1, wherein the companion SoC further comprises a component configured to route communication between the subsystem and the ML accelerator.

4. The system of claim 1, wherein the ML accelerator comprises:
the ML model configured to validate that received sensor data meets quality criteria; and
a signature generation model configured to extract identifying features from validated sensor data.

5. The system of claim 1, wherein the firewall is further configured to:
restrict access to the one or more ML models to only the ML accelerator and the subsystem; and
restrict access to sensor calibration data.

6. The system of claim 1, wherein the subsystem comprises:
a rate limiter configured to throttle authentication attempts; and
a secure storage for the encrypted biometric templates, wherein the encrypted biometric templates are encrypted with a hardware-protected device-specific key.

7. The system of claim 1, wherein the companion SoC further comprises:
a second subsystem configured to preprocess raw sensor data before ML processing,
wherein the firewall is configured to allow the second subsystem access to raw sensor data.

8. The system of claim 1, wherein the companion SoC is configured to:
load at least one of the one or more ML models based on authentication requests; and
maintain separate secure memory regions for template storage and model execution.

9. The system of claim 1, further comprising:
a control unit configured to coordinate workloads across subsystems through secure shared memory regions.

10. The system of claim 1, wherein the companion SoC is configured to:
process biometric sensor data;
generate a signed authentication result message with a freshness indicator; and
transmit the signed authentication result message to the main SoC, wherein the biometric sensor data is not transmitted to the main SoC.

11. A method of securely processing biometric sensor data, the method comprising:
encrypting a set of machine-learning (ML) models using a subsystem of a wearable device that is isolated from a main system-on-a-chip (SoC) of the wearable device;
storing, via the subsystem, encrypted biometric templates, wherein access to the encrypted biometric templates is restricted to the subsystem;
verifying, using the subsystem, authenticity of an ML model from the set of ML models prior to use of the ML model;
validating biometric sensor data by applying the ML model using an ML accelerator of the wearable device, wherein access to the biometric sensor data is restricted to the ML accelerator;
generating, via the ML accelerator, a biometric signature from validated biometric sensor data, wherein the biometric signature is generated using at least one ML model of the set of ML models; and
authenticating, using the subsystem, the biometric signature against stored encrypted biometric templates.

12. The method of claim 11, further comprising deriving, via the subsystem, cryptographic keys for secure communication with the main SOC.

13. The method of claim 11, further comprising, routing communication between the subsystem and the ML accelerator through one or more ring buffers in shared memory.

14. The method of claim 11, wherein:
validating the biometric sensor data comprises determining whether the biometric sensor data meets one or more quality criteria; and
generating the biometric signature comprises extracting, using a second ML model of the set of ML models, identifying features from validated biometric sensor data.

15. The method of claim 11, further comprising:
encrypting the encrypted biometric templates using a hardware-protected device-specific key.

16. A non-transitory, computer-readable storage medium storing a set of instructions that, when executed by a computing system, cause the computing system to perform a process, the process comprising:
encrypting a set of machine learning (ML) models using a subsystem of a wearable device that is isolated from a main system-on-a-chip (SoC) of the wearable device;
storing, via the subsystem, encrypted biometric templates, wherein access to the encrypted biometric templates is restricted to the subsystem;
verifying, using the subsystem, authenticity of an ML model from the set of ML models prior to use of the ML model;
validating biometric sensor data by applying the ML model using an ML accelerator of the wearable device, wherein access to the biometric sensor data is restricted to the ML accelerator;
generating, via the ML accelerator, a biometric signature from validated biometric sensor data, wherein the biometric signature is generated using at least one ML model of the set of ML models; and
authenticating, using the subsystem, the biometric signature against stored encrypted biometric templates.

17. The non-transitory, computer-readable storage medium of claim 16, wherein the set of instructions further comprise instructions for:
preprocessing sensor data prior to providing the sensor data to the ML accelerator, wherein the preprocessing is performed by a second subsystem that is allowed access to the sensor data.

18. The non-transitory, computer-readable storage medium of claim 17, wherein the set of instructions further comprise instructions for:
dynamically loading one or more of the set of ML models based on authentication requests.

19. The non-transitory, computer-readable storage medium of claim 17, wherein the set of instructions further comprise instructions for:
coordinating workloads across subsystems using shared memory regions.

20. The non-transitory, computer-readable storage medium of claim 17, wherein the set of instructions further comprise instructions for:
validating biometric sensor data comprises generating a signed authentication result message with a freshness indicator;
the signed authentication result message is transmitted to the main SoC; and
the biometric sensor data is not transmitted to the main SoC.
